(19) United States
(12) Patent Application Publication
(10) Pub. No.: US 2024/0334428 A1
(43) Pub. Date: Oct. 3, 2024

(54) INDICATING SOUNDING REFERENCE SIGNAL PORTS FOR PHYSICAL UPLINK SHARED CHANNELS FOR SIMULTANEOUS TRANSMISSION ACROSS MULTIPLE PANELS WITH SHARED PORTS

(71) Applicant: QUALCOMM Incorporated, San Diego, CA (US)

(72) Inventors: Yitao CHEN, San Marcos, CA (US); Mostafa KHOSHNEVISAN, San Diego, CA (US)

(21) Appl. No.: 18/402,523

(22) Filed: Jan. 2, 2024

Related U.S. Application Data
(60) Provisional application No. 63/492,355, filed on Mar. 27, 2023.

(51) Int. Cl. H04W 72/1268; H04L 5/00

(52) U.S. Cl. CPC H04W 72/1268; H04L 5/0048; H04L 5/0053

(57) ABSTRACT

A method that may be performed by a user equipment (UE) includes receiving, from a network entity, a configuration of at least first and second SRS resource sets for codebook-based PUSCH transmissions; receiving, from the network entity, signaling scheduling the UE for simultaneous transmission of at least one PUSCH using uplink ports shared across multiple panels of the UE, wherein the signaling indicates a first set of PUSCH ports corresponding to a subset of SRS ports associated with SRS resources in the first SRS resource set and a second set of PUSCH ports corresponding to a subset of SRS ports associated with SRS resources in the second SRS resource set; and transmitting the at least one PUSCH via a first panel of the UE using the first set of PUSCH ports and via a second panel of the UE using the second set of PUSCH ports.

### CROSS REFERENCE TO RELATED APPLICATIONS

This application claims benefits of and priority to U.S. Provisional Patent Application No. 63/492,355, filed on Mar. 27, 2023, which is assigned to the assignee hereof and herein incorporated by reference in the entirety as if fully set forth below and for all applicable purposes.

### BACKGROUND

### Field of the Disclosure

Aspects of the present disclosure relate to wireless communications, and more particularly, to techniques for indicating sounding reference signal (SRS) ports for physical uplink shared channels (PUSCHs) for simultaneous transmission across multiple panels (STxMP) with shared ports.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a user equipment (UE). The method includes receiving, from a network entity, a configuration of at least first and second sounding reference signal (SRS) resource sets for codebook-based physical uplink shared channel (PUSCH) transmissions; receiving, from the network entity, signaling scheduling the UE for simultaneous transmission of at least one PUSCH using uplink ports shared across multiple panels of the UE, wherein the signaling indicates a first set of PUSCH ports corresponding to a subset of SRS ports associated with SRS resources in the first SRS resource set and a second set of PUSCH ports corresponding to a subset of SRS ports associated with SRS resources in the second SRS resource set; and transmitting the at least one PUSCH via a first panel of the UE using the first set of PUSCH ports and via a second panel of the UE using the second set of PUSCH ports.

Another aspect provides a method for wireless communications by a network entity. The method includes transmitting, to a UE, a configuration of at least first and second SRS resource sets for codebook-based PUSCH transmissions; transmitting, to the UE, signaling scheduling the UE for simultaneous transmission of at least one PUSCH using uplink ports shared across multiple panels of the UE, wherein the signaling indicates a first set of PUSCH ports corresponding to a subset of SRS ports associated with SRS resources in the first SRS resource set and a second set of PUSCH ports corresponding to a subset of SRS ports associated with SRS resources in the second SRS resource set; and receiving the at least one PUSCH, wherein the at least one PUSCH is transmitted via a first panel of the UE using the first set of PUSCH ports and via a second panel of the UE using the second set of PUSCH ports.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 is a call flow diagram illustrating an example of codebook based uplink (UL) transmission.

FIG. 6 is a call flow diagram illustrating an example of non-codebook based UL transmission.

FIG. 7 shows a table of precoding matrices W and corresponding transmitted precoding matrix indicator (TPMI) indexes for a single-layer transmission using two antenna ports.

FIG. 8 shows a table of precoding matrices W and corresponding TPMI indexes for a single-layer transmission using four antenna ports.

FIG. 9 shows a table of precoding matrices W and corresponding TPMI indexes for a two-layer transmission using four antenna ports.

FIG. 10 shows a table for “Precoding information and number of layers” for four antenna ports.

FIG. 11 shows a table for “Precoding information and number of layers” for four antenna ports.

FIG. 12 shows a table for “Precoding information and number of layers” for two antenna ports.

FIG. 13 shows an example of a single-downlink control information (DCI) based spatial division multiplexing (SDM) PUSCH STxMP scheme in block form.

FIG. 14 shows an example of a single-DCI based single frequency network (SFN) PUSCH STxMP scheme in block form.

FIGS. 15A, 15B, 15C, 15D, 15E, and 15F depict simultaneous uplink transmission of a PUSCH 1 and a PUSCH 2 on resources at least partially overlapping in time.

FIG. 16 depicts a process flow for communications in a network between a UE and a network entity.

FIG. 17 shows a table for interpreting a “Precoding information and number of layers” field of a DCI scheduling STxMP PUSCHs using an SRS resource with 2 ports, with a maximum rank of 1.

FIG. 18 shows a table for interpreting a “Precoding information and number of layers” field of a DCI scheduling STxMP PUSCHs using an SRS resource with 4 ports, with a maximum rank of 1.

FIG. 19 shows a table for interpreting a “Precoding information and number of layers” field of a DCI scheduling STxMP PUSCHs using an SRS resource with 4 ports, with a maximum rank of 2.

FIG. 20 shows, in block form, an example configuration of an SRS resource wherein PUSCH ports associated with a first SRS resource set correspond to a subset of SRS ports.

FIG. 21 shows, in block form, an example configuration of an SRS resource, wherein at least half of the rows of a precoding matrix used for a PUSCH transmission are zero.

FIGS. 22A and 22B illustrate examples of precoding matrices dynamically indicated by a “Precoding information and number of layers” field in a DCI that a UE may use in determining a technique to use for STxMP.

FIG. 23 depicts a method for wireless communications.

FIG. 24 depicts a method for wireless communications.

FIG. 25 depicts aspects of an example communications device.

FIG. 26 depicts aspects of an example communications device.

### DETAILED DESCRIPTION

Aspects of the present disclosure provide apparatuses, methods, processing systems, and computer-readable mediums for indicating sounding reference signal (SRS) ports for physical uplink shared channels (PUSCHs) for simultaneous transmission across multiple panels (STxMP) with shared ports.

Some wireless networks support codebook-based transmission and non-codebook-based transmission schemes for uplink transmissions. Codebook-based UL transmission is based on network configuration and can be used in cases where reciprocity may not hold.

For codebook-based uplink transmission, a UE may transmit (non-precoded) sounding reference signals (SRS) with up to 2 SRS resources (with each resource having 1, 2, or 4 ports). The network (e.g., a base station or gNB) measures the SRS and, based on the measurement, selects one SRS resource and a wideband precoder (also referred to as a precoding matrix) to be applied to the SRS ports within the selected SRS resource. The network may configure the UE with the selected SRS resource via an SRS resource indicator (SRI) and with the wideband precoder via a transmitted precoding matrix indicator (TPMI). For a dynamic grant, the SRI and the TPMI may be configured via an uplink (UL) downlink control information (DCI), for example, scheduling a physical uplink shared channel (PUSCH). The UE determines the selected SRS resource from the SRI and the precoding matrix from the TPMI and transmits PUSCH accordingly.

In some cases, for codebook-based uplink transmission, a UE may be configured with one SRS resource set with “usage” set to “codebook.” The SRS resource set may have up to 4 SRS resources and each SRS resource may be configured (e.g., via radio resource control (RRC)) with a number of SRS ports. The SRI field in the UL DCI indicates one SRS resource, and the number of ports configured for the indicated SRS resource determines the number of antenna ports to be used for transmitting PUSCH, which is typically transmitted with a same spatial domain filter (UL beam) as the indicated SRS resources. A number of layers (also referred to as a rank) and a TPMI (indicating a precoder) for the scheduled PUSCH may be determined from a separate DCI field, which may be referred to as a “Precoding information and number of layers” field.

In some cases, a UE may indicate a maximum number of SRS ports the UE supports for a beam indicated in a beam report. For example, this indication may be provided via a reported capability index, perhaps based on a best antenna panel for reception or transmission (Rx/Tx) of a beam. A gNB may schedule SRS for codebook-based PUSCH with a corresponding port number if UL sounding is needed, and will schedule PUSCH with a maximum layer number, limited by the maximum number of ports the UE supports.

When a UE has multiple transmit antenna panels, ports supported by the UE are typically able to be used for transmitting via any of the antenna panels. In some cases, a UE may be configured to transmit a single uplink channel (e.g., a physical uplink shared channel (PUSCH)) via all of the digital ports and antenna panels the UE has, while in other cases the UE may be configured to transmit multiple uplink channels via the digital ports and antenna panels. However, the total number of digital ports supported by the UE is unaffected by the UE having multiple antenna panels. Thus, when the UE is configured to transmit via the multiple antenna panels, it is desirable to limit the number of ports used for each transmission, so that the UE is able to make all of its scheduled transmissions without running out of ports.

Aspects of the present disclosure provide techniques for a UE to be configured to transmit one or more uplink channels while sharing digital ports across multiple antenna panels. The described aspects include signaling that indicates a first set of SRS ports associated with a first SRS resource in a first SRS resource set and a second set of SRS ports associated with a second SRS resource in a second SRS resource set. The UE may then transmit at least one PUSCH via a first antenna panel using the first set of PUSCH ports and via a second antenna panel using the second set of SRS ports.

Aspects of the present disclosure provide techniques for a UE to determine that a set of digital ports for a transmission is dynamically configured or fixed, based on a “Precoding information and number of layers” field in a downlink control information (DCI) scheduling the UE to transmit the uplink channels.

By enabling a UE to be scheduled to simultaneously transmit uplink channels with shared digital ports between panels, transmissions from the UE may be more reliably received by network entities. In addition, more efficient usage of time and/or frequency resources in wireless communications systems may be enabled.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

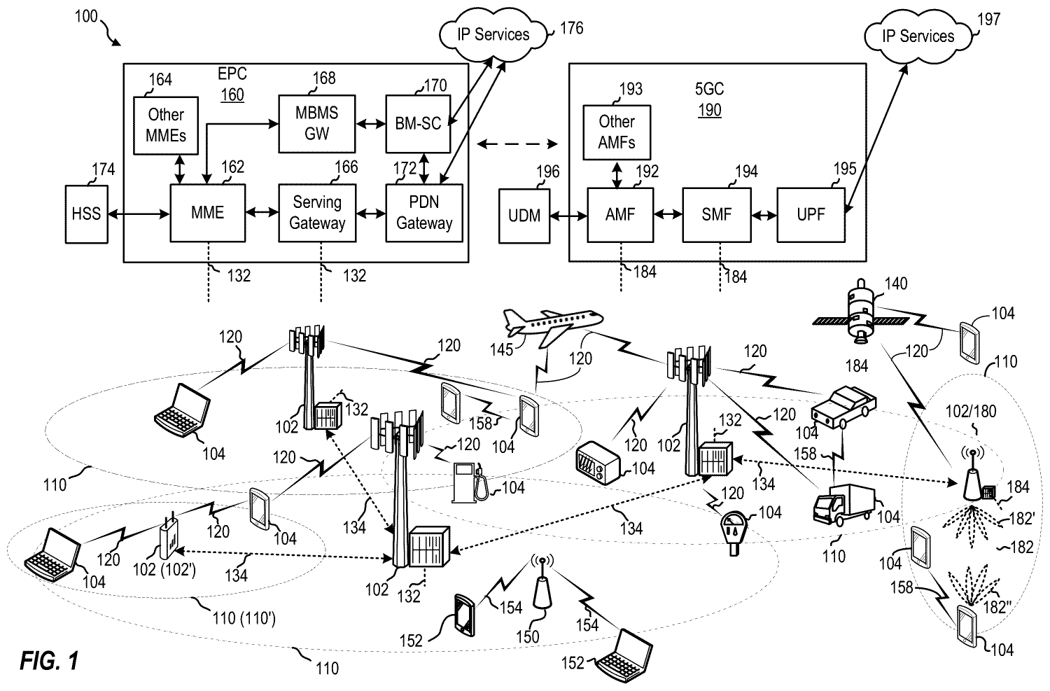

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

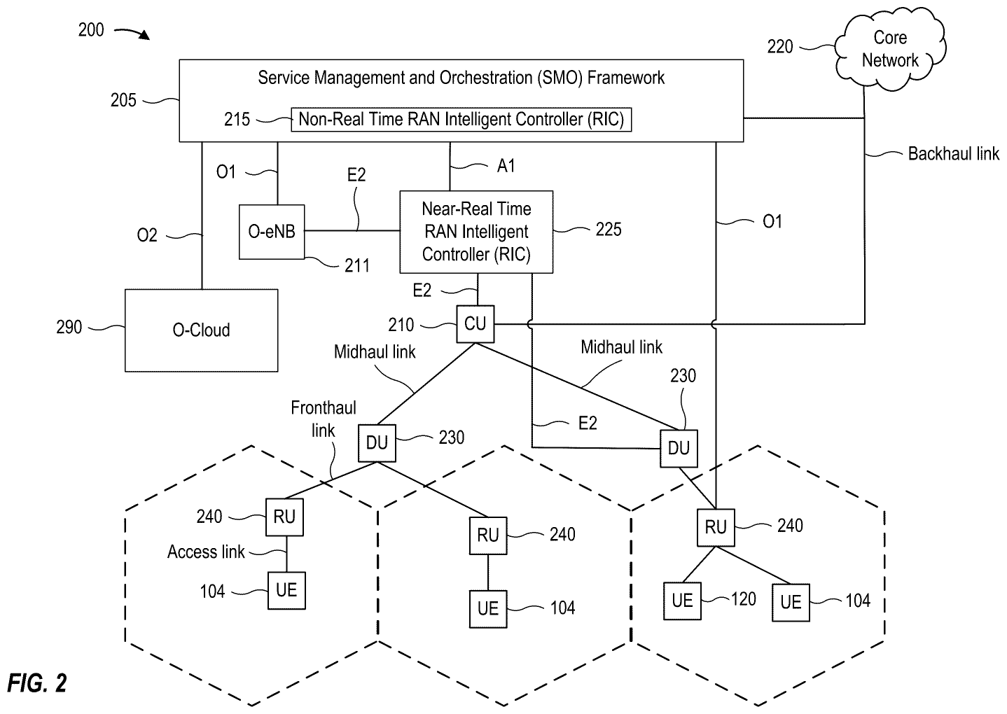

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHZ-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mm Wave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an FI interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240, and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

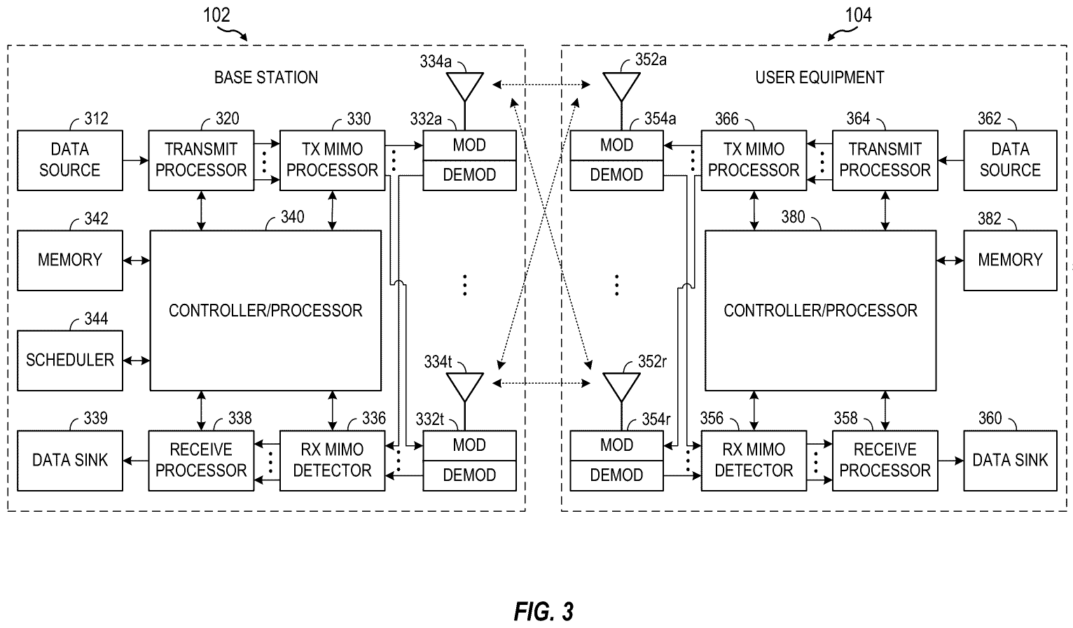

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

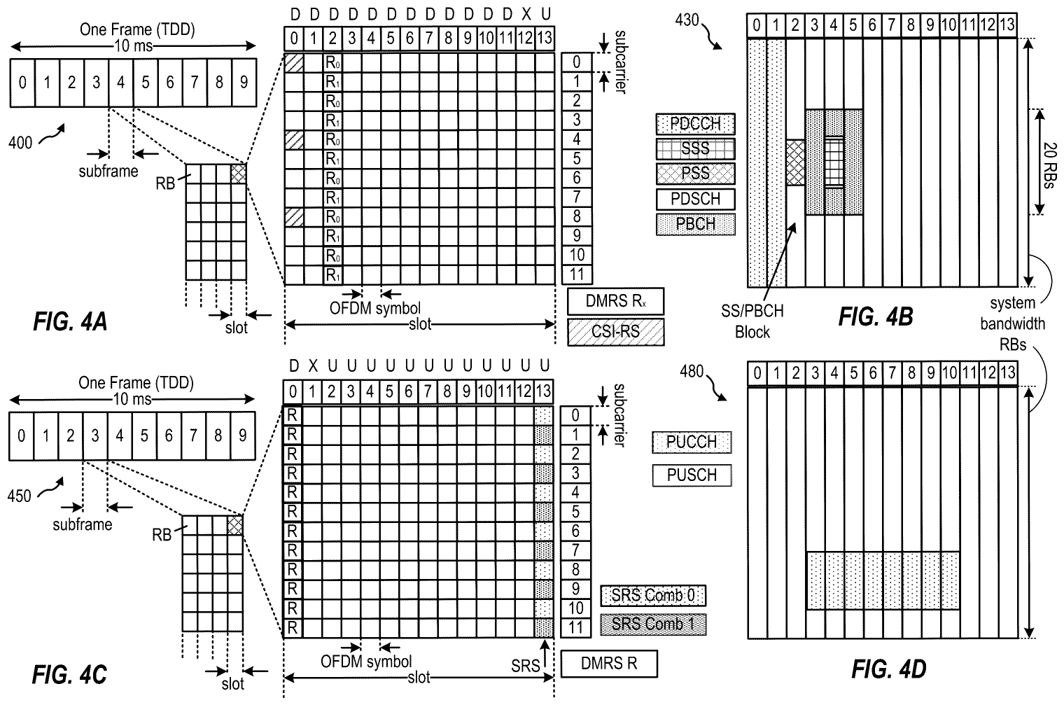

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number. The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of Codebook and Non-Codebook Based UL Transmissions

Some deployments support codebook-based transmission and non-codebook-based transmission schemes for uplink transmissions with wideband precoders, also referred to as precoding matrices. Codebook-based UL transmission is based on BS configuration and can be used in cases where reciprocity may not hold.

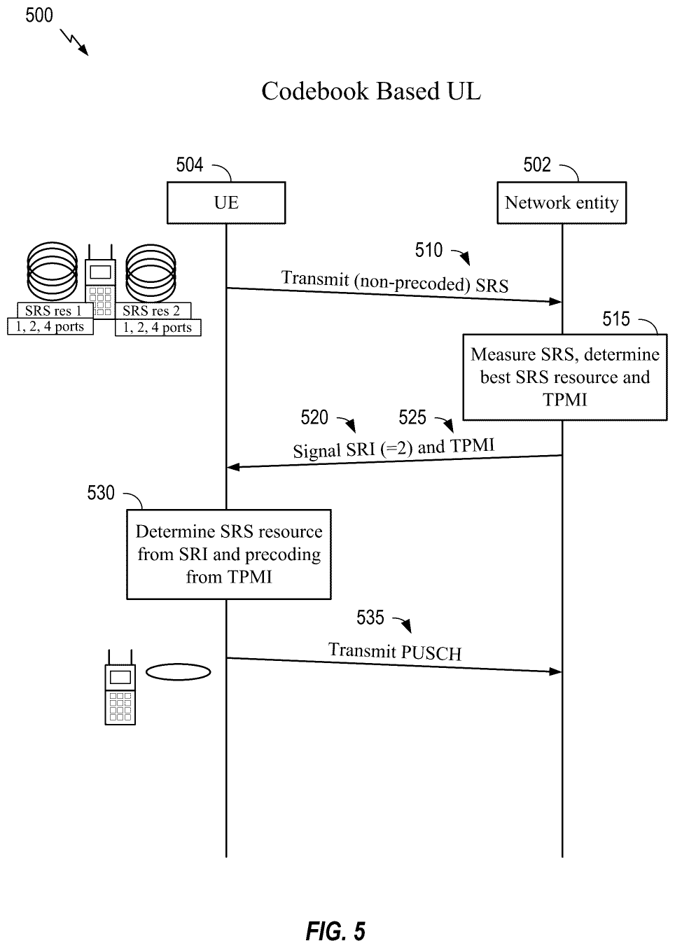

FIG. 5 is a call flow diagram 500 illustrating an example of conventional codebook (CB) based UL transmission using a wideband precoder. The example CB based UL transmission may occur between a UE 504 and a network entity 502 (e.g., a gNB). In some aspects, the network entity 502 may be an example of the BS 102 depicted and described with respect to FIGS. 1 and 3 or a disaggregated base station depicted and described with respect to FIG. 2. Similarly, the UE 504 may be an example of UE 104 depicted and described with respect to FIGS. 1 and 3. However, in other aspects, the UE may be another type of wireless communications device and the network entity may be another type of network entity or network node, such as those described herein. As illustrated, the UE 504 transmits (non-precoded) SRS 510 with up to 2 SRS resources (SRS res 1 and SRS res 2) with each SRS resource having 1, 2, or 4 ports. At 515, the network entity 502 measures the SRS 510 and, based on the measurement, selects one SRS resource and a wideband precoder to be applied to the SRS ports within the selected SRS resource. In the example, the network entity 502 selects the SRS resource SRS res 2.

As illustrated, the network entity 502 configures (e.g., by signaling the configuration) the UE 504 with the selected SRS resource via an SRS resource indicator (SRI) 520 and with the wideband precoder via a transmitted precoding matrix indicator (TPMI) 525. For a dynamic grant, the SRI 520 and TPMI 525 may be configured via DCI format 0_1. For a configured grant (e.g., for semi-persistent uplink), SRI 520 and TPMI 525 may be configured via RRC signaling or in a DCI.

At 530, the UE 502 determines the selected SRS resource from the SRI 520 and a precoding matrix from the TPMI 525. The UE 502 transmits a PUSCH 535 using the selected SRS resource and the precoding matrix indicated by the TPMI 525.

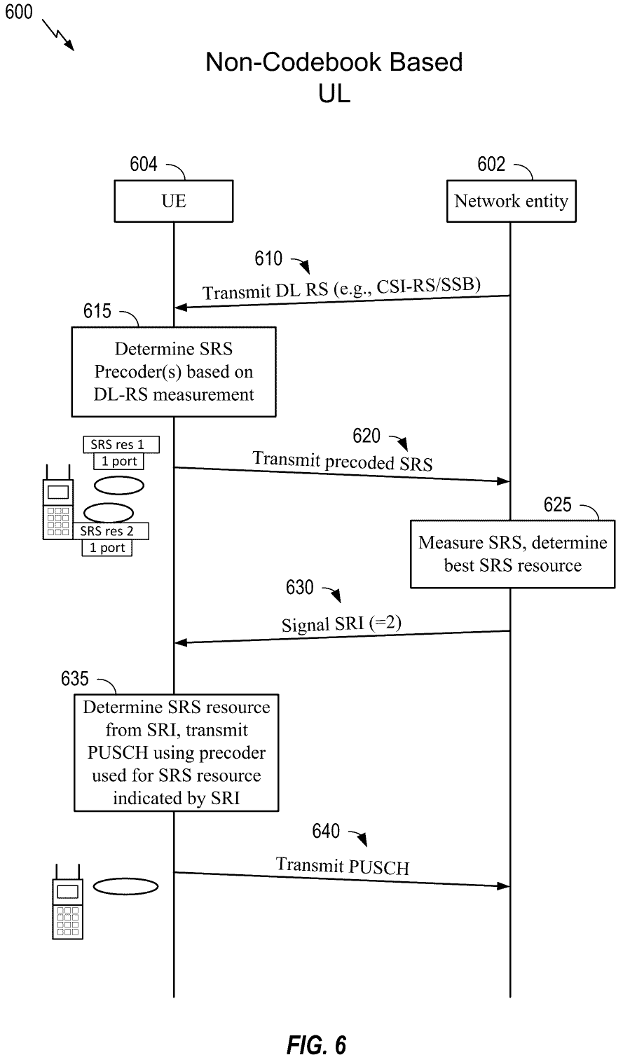

FIG. 6 is a call flow diagram 600 illustrating an example of non-codebook (NCB) based UL transmission. The example NCB based UL transmission may occur between a UE 604 and a network entity 602 (e.g., a gNB). In some aspects, the network entity 602 may be an example of the BS 102 depicted and described with respect to FIGS. 1 and 3 or a disaggregated base station depicted and described with respect to FIG. 2. Similarly, the UE 604 may be an example of UE 104 depicted and described with respect to FIGS. 1 and 3. However, in other aspects, the UE may be another type of wireless communications device and the network entity may be another type of network entity or network node, such as those described herein. As illustrated, the network entity 602 transmits one or more DL RS 610, e.g., CSI-RS or an SSB. At 615, the UE 604 determines one or more SRS precoders based on measurements of the DL RS 610. The UE 604 transmits precoded SRS 620 using the precoders determined at 615. While the example shows 2 SRS resources, the UE may transmit with up to 4 SRS resources (with each resource having 1 port). At 625, the network entity 602 measures the SRS 620 and, based on the measurement, selects one or more SRS resources from the SRS resources the UE used in transmitting the SRS 620. In this case, since the UE 604 transmitted the SRS using a precoder, by selecting the SRS resource (e.g., SRS res 2), the network entity 602 is effectively also selecting the precoder. For non-codebook based UL transmission, each SRS resource corresponds to a layer. The precoder of the layer is actually the precoder of the SRS which is emulated by the UE. Selecting N SRS resources (e.g., by the network entity 602) means the rank of the ensuing transmission is N. The UE is to transmit PUSCH using the same precoder as the SRS.

As illustrated, the network entity 602 configures (e.g., by transmitting the configuration) the UE 604 with the selected SRS resource via transmitting an SRI 630 that corresponds to the selected SRS resource. For a dynamic grant, the SRI 630 may be configured via DCI format 0_1. For a configured grant, the SRI may be configured via RRC signaling or in a DCI.

At 635, the UE 602 determines the selected SRS resource from the SRI 630. The UE 602 transmits a PUSCH 640 using the selected SRS resource and the precoding matrix that was used in transmitting the SRS 620 corresponding to the selected SRS resource.

### Aspects Related to Precoding Matrices and Transmit Matrix Precoding Indicator Signaling

According to aspects of the present disclosure, when a wireless communications system uses a spatial division multiplexing (SDM) scheme with a UE that shares digital ports between antenna panels, the UE may be configured with a single maximum number of layers (e.g., 1, 2, or 4 layers) that is applied to the first SRS resource set and the second SRS resource set. That is, a sum of the number of layers of the first SRS resource set and the number of layers of the second SRS resource set is constrained to be less than or equal to the single maximum number of layers. The configuration of this single maximum number of layers may be independent from a maximum number of layers in single TRP (sTRP) transmission schemes, which may be configured by a parameter referred to as maxRank or Lmax.

It may be desirable to develop techniques enabling the total number of PUSCH antenna ports used by a UE for SDM communications schemes and sTRP communications schemes to be the same.

In typical communications systems, for each combination of a number of layers (e.g., 1, 2, or 4) and a number of PUSCH ports, a set of precoding matrices may be defined (e.g., in a communications specification document) with corresponding TPMI indices. The various precoding matrices in the set may be described as non-coherent, partial-coherent, and coherent, depending on whether the precoder indicates only a single port is utilized for transmitting a layer, only a subset (more than one) of ports are utilized for transmitting a layer, or all ports are utilized for transmitting a layer.

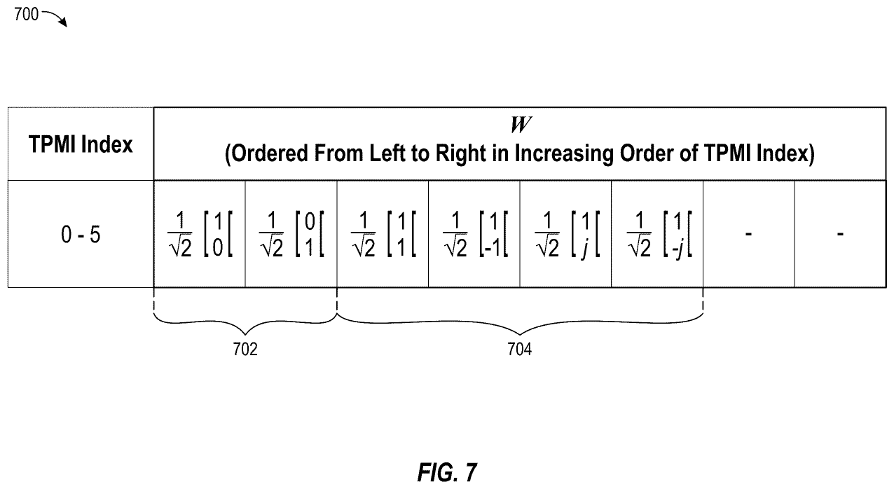

FIG. 7 shows a table 700 of precoding matrices W and corresponding TPMI indexes for a single-layer transmission using two antenna ports, according to aspects of the present disclosure. The precoding matrices shown at 702 are non-coherent, because each matrix has only one non-zero value, and thus only one of the two ports is used for transmitting a layer. The precoding matrices shown at 704 are coherent, because all of the values in the matrices are non-zero, and thus all of the two ports are used for transmitting a layer.

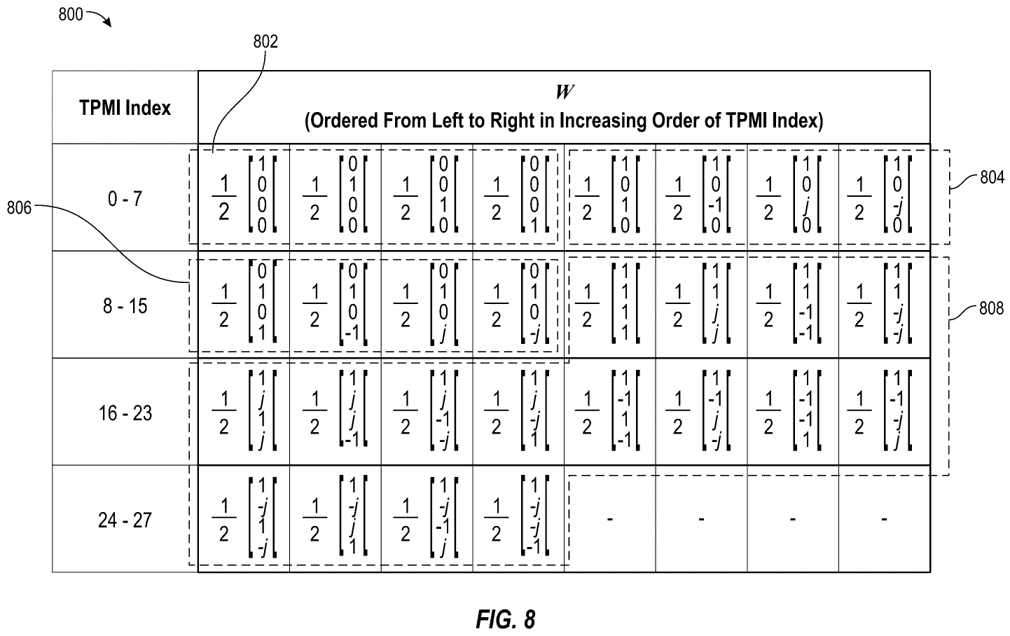

FIG. 8 shows a table 800 of precoding matrices W and corresponding TPMI indexes for a single-layer transmission using four antenna ports with transform precoding disabled, according to aspects of the present disclosure. The precoding matrices shown at 802 are non-coherent, because each matrix has only one non-zero value, and thus only one of the four ports is used for transmitting a layer. The precoding matrices shown at 804 and 806 are partial-coherent, because each matrix has more than one (e.g., two) non-zero value and at least one zero value, and thus only a subset of the four ports is used for transmitting a layer. The remaining precoding matrices shown at 808 are coherent, because all of the values in the matrices are non-zero, and thus all of the four ports are used for transmitting a layer.

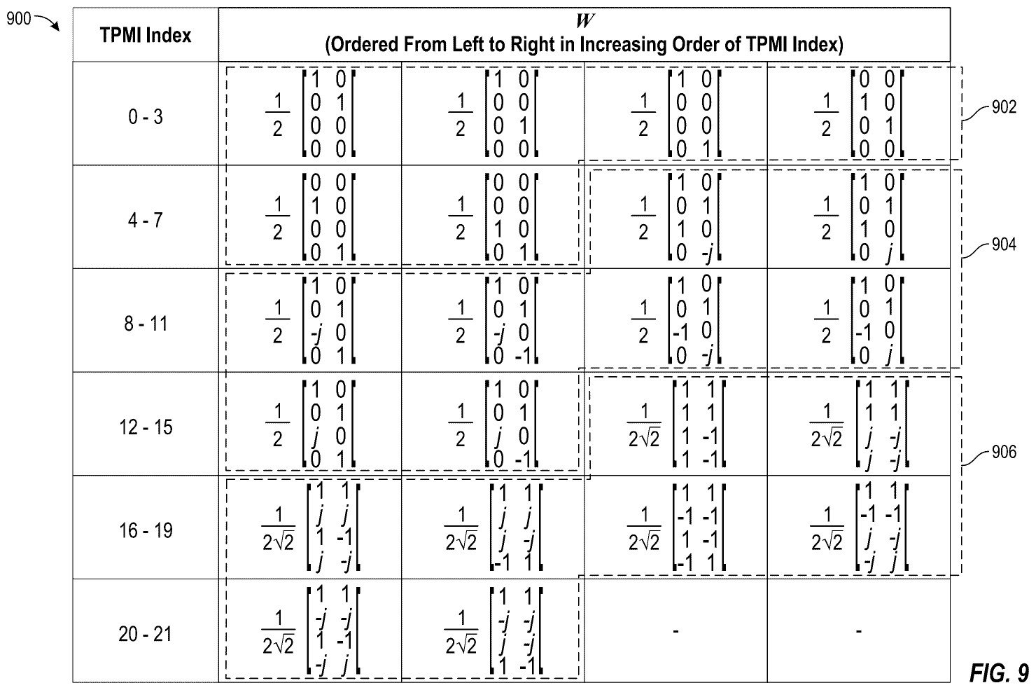

FIG. 9 shows a table 900 of precoding matrices W and corresponding TPMI indexes for a two-layer transmission using four antenna ports with transform precoding disabled, according to aspects of the present disclosure. The precoding matrices shown at 902 are non-coherent, because each column of each matrix has only one non-zero value, and thus only one of the four ports is used for transmitting the layer corresponding to that column. The precoding matrices shown at 904 are partial-coherent, because each column of each matrix has more than one non-zero value and at least one zero value, and thus only a subset of the four ports is used for transmitting the layer corresponding to that column. The remaining precoding matrices shown at 906 are coherent, because all of the values in each of the columns of the matrices are non-zero, and thus all of the four ports are used for transmitting the layer corresponding to each column.

A TPMI index may be indicated in a DCI field named “Precoding information and number of layers.” The value conveyed in the DCI field named “Precoding information and number of layers” may be used as a reference in one or more tables corresponding to different numbers of antenna ports and/or different maximum ranks. From those tables, a TPMI index may be determined, which corresponds to a precoding matrix, such as the precoding matrices shown in FIGS. 7-9.

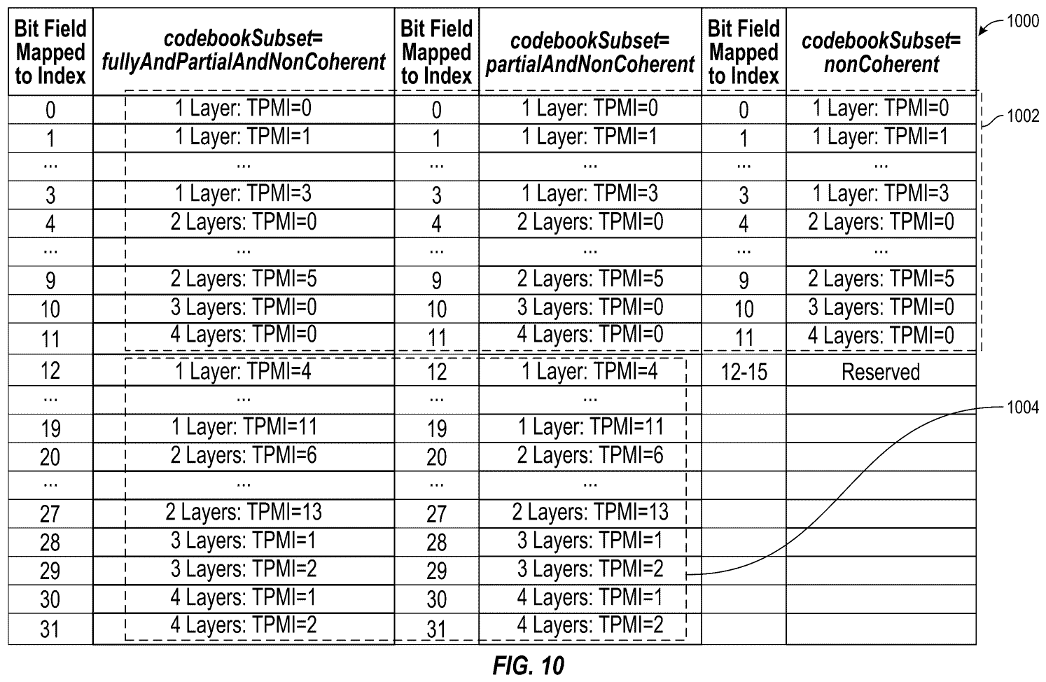

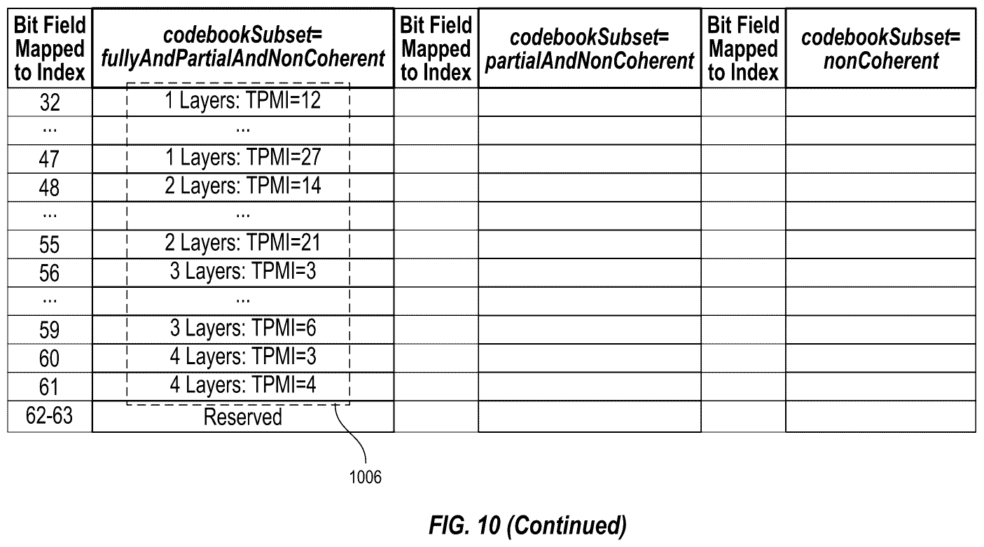

FIG. 10 shows a table 1000 for “Precoding information and number of layers” for four antenna ports if: transform precoding is disabled; maximum rank is 2, 3, or 4; and “uplink full power transmission” (also referred to as ul-FullPowerTransmission) is not configured, is configured to fullpowerMode2, or is configured to fullpower. When the “Precoding information and number of layers” field has a value between 0 and 11 (inclusive), as shown at 1002, the corresponding TPMI indices have values between 0 and 3 (inclusive) for a 1-layer transmission, and the corresponding precoding matrices are non-coherent, as shown at 802 in FIG. 8. When the “Precoding information and number of layers” field has a value between 0 and 11 (inclusive), as shown at 1002, the corresponding TPMI indices have values between 0 and 5 (inclusive) for 2-, 3-, and 4-layer transmissions, and the corresponding precoding matrices are non-coherent, as shown at 902 in FIG. 9.

When the “Precoding information and number of layers” field has a value between 12 and 19 (inclusive), as shown at 1004, the corresponding TPMI indices have values between 4 and 11 (inclusive) for a 1-layer transmission, and the corresponding precoding matrices are partial-coherent, as shown at 804 and 806 in FIG. 8. When the “Precoding information and number of layers” field has a value between 20 and 27 (inclusive), as shown at 1004, the corresponding TPMI indices have values between 6 and 13 (inclusive) for a 2-layer transmission, and the corresponding precoding matrices are partial-coherent, as shown at 904 in FIG. 9. When the “Precoding information and number of layers” field has a value between 28 and 31 (inclusive), as shown in at 1004, the corresponding TPMI indices have values of 1 or 2 for 3- and 4-layer transmissions, and the corresponding precoding matrices are partial-coherent.

When the “Precoding information and number of layers” field has a value between 32 and 47 (inclusive), as shown in at 1006, the corresponding TPMI indices have values between 12 and 27 (inclusive) for a 1-layer transmission, and the corresponding precoding matrices are coherent, as shown at 808 in FIG. 8. When the “Precoding information and number of layers” field has a value between 48 and 55 (inclusive), as shown at 1006, the corresponding TPMI indices have values between 14 and 21 (inclusive) for a 2-layer transmission, and the corresponding precoding matrices are coherent, as shown at 906 in FIG. 9. When the “Precoding information and number of layers” field has a value between 56 and 59 (inclusive), as shown at 1004, the corresponding TPMI indices have values between 3 and 6 (inclusive) for a 3-layer transmission, and the corresponding precoding matrices are coherent. When the “Precoding information and number of layers” field has a value of 60 or 61, as shown in at 1004, the corresponding TPMI indices have values of 3 or 4 for a 4-layer transmission, and the corresponding precoding matrices are coherent.

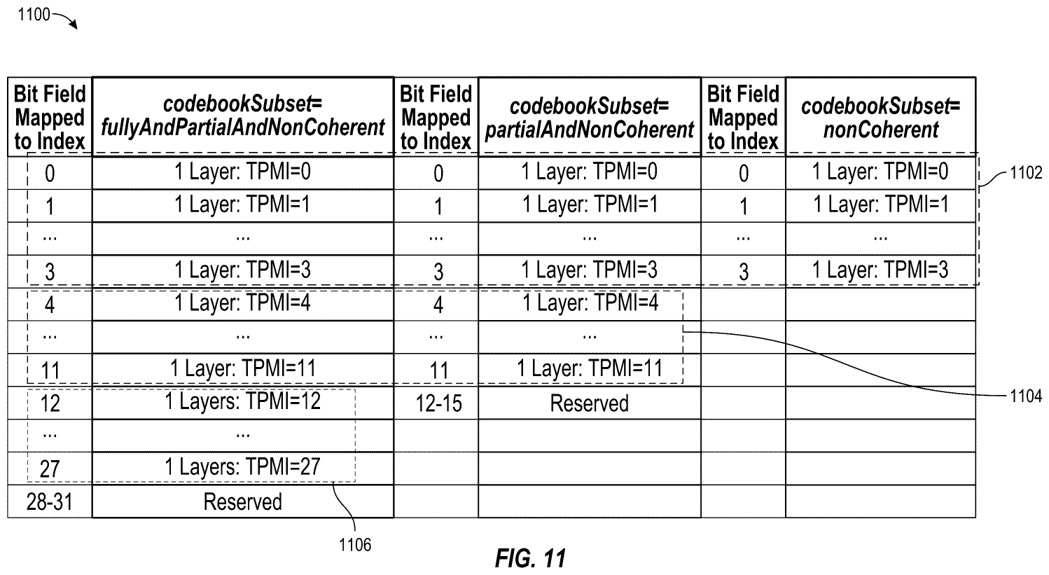

FIG. 11 shows a table 1100 for “Precoding information and number of layers” for four antenna ports if: transform precoding is enabled; and “uplink full power transmission” (also referred to as ul-FullPowerTransmission) is not configured or is configured to fullpowerMode2. The table 1100 is also for “Precoding information and number of layers” for four antenna ports if: transform precoder is disabled; maximum rank is 1; and “uplink full power transmission” (also referred to as ul-FullPowerTransmission) is not configured, is configured to fullpowerMode2, or is configured to fullpower. When the “Precoding information and number of layers” field has a value between 0 and 3 (inclusive), as shown in at 1102, the corresponding precoding matrices are non-coherent. When the “Precoding information and number of layers” field has a value between 4 and 11 (inclusive), as shown in at 1104, the corresponding precoding matrices are partial-coherent. And, when the “Precoding information and number of layers” field has a value between 12 and 27 (inclusive), as shown in at 1106, the corresponding precoding matrices are coherent.

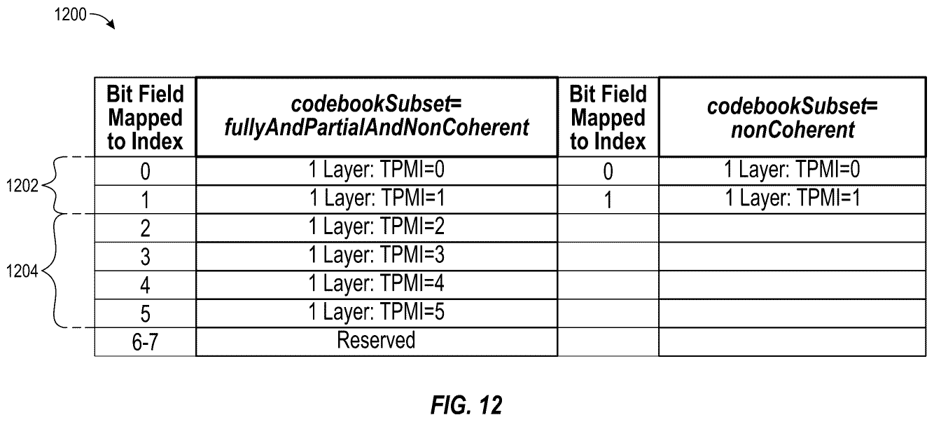

FIG. 12 shows a table 1200 for “Precoding information and number of layers” for two antenna ports if transform precoder is enabled and “uplink full power transmission” (also referred to as ul-FullPowerTransmission) is not configured, is configured to fullpowerMode2, or is configured to fullpower. The table 1200 is also for “Precoding information and number of layers” for two antenna ports if transform precoder is disabled; maximum rank is 1; and “uplink full power transmission” (also referred to as ul-FullPowerTransmission) is not configured, is configured to fullpowerMode2, or is configured to fullpower. When the “Precoding information and number of layers” field has a value of 0 or 1, as shown in at 1202, the corresponding precoding matrices are non-coherent. When the “Precoding information and number of layers” field has a value between 2 and 5 (inclusive), as shown in at 1204, the corresponding precoding matrices are coherent.

In aspects of the present disclosure, a wireless communications system may communicate (e.g., transmit and receive) using a single-DCI based SDM PUSCH simultaneous transmission with multiple panels (STxMP) scheme. A simultaneous transmission (of a PUSCH) with two panels scheme may be referred to as an STx2P scheme. In such a scheme, a single DCI schedules transmission of a PUSCH with two sets of DMRS ports and/or layers transmitted from two panels with different transmit beams and/or different precoders and/or different power control parameters.

According to aspects of the present disclosure, in a single-DCI based SDM PUSCH STxMP scheme, two sets of layers may be associated with 2 SRS resource sets.

In aspects of the present disclosure, a DCI can include an SRS resource set indicator field and two SRI and/or TPMI fields. In such aspects, each of the two SRI fields indicates an SRS resource included in the SRS resource set indicated by the SRS resource set indicator field.

According to aspects of the present disclosure, dynamic switching between an sTRP scheme and an SDM scheme may be based on an SRS resource set indicator. When the SRS resource set indicator has a value of ‘00,’ then PUSCH is only associated with the first SRS resource set (which also indicates the sTRP scheme). When the SRS resource set indicator has a value of ‘01,’ then PUSCH is only associated with the second SRS resource set (which also indicates the sTRP scheme). When the SRS resource set indicator has a value of ‘10,’ then PUSCH is associated with both SRS resource sets (which also indicates the SDM scheme). In transmitting from the two panels, a UE may transmit using the following rank combinations: 1+1 layers (i.e., 1 layer on a first panel and 1 layer on a second panel), 1+2 layers (i.e., 1 layer on a first panel and 2 layers on a second panel), 2+1 layers (i.e., 2 layers on a first panel and 1 layer on a second panel), or 2+2 layers (i.e., 2 layers on a first panel and 2 layers on a second panel).

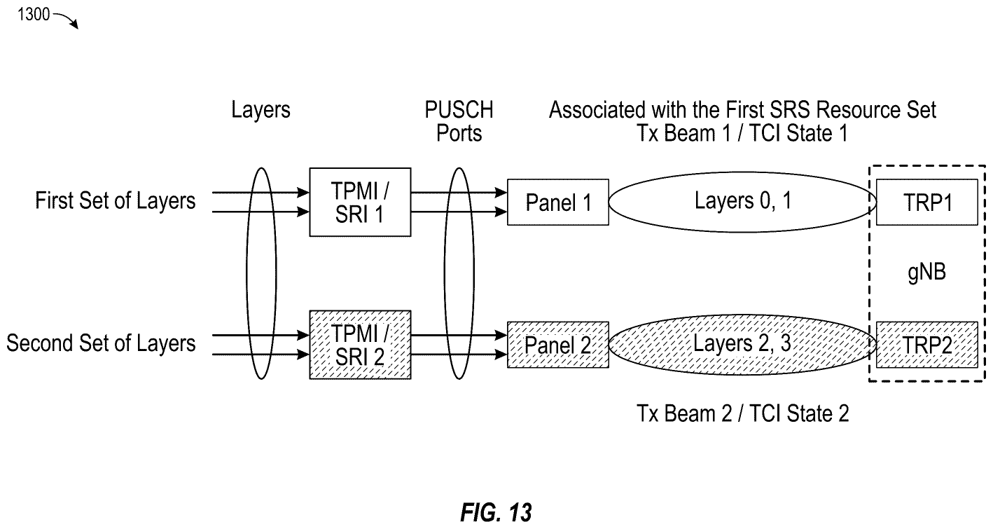

FIG. 13 shows an example 1300 of a single-DCI based SDM PUSCH STxMP scheme in block form, according to aspects of the present disclosure. As illustrated, a first set of layers are associated with a first TPMI or a first SRI. The first set of layers are assigned to the PUSCH ports associated with the first TPMI or the first SRI. The signals for transmission in the first set of layers are transmitted via a first panel (Panel 1) of a UE and form a two layer transmission on layers 0 and 1 to a first TRP (TRP 1). Similarly, a second set of layers are associated with a second TPMI or a second SRI. The second set of layers are assigned to the PUSCH ports associated with the second TPMI or the second SRI. The signals for transmission in the second set of layers are transmitted via a second panel (Panel 2) of the UE and form a two layer transmission on layers 2 and 3 to a second TRP (TRP 2).

In aspects of the present disclosure, a wireless communications system may use a single frequency network (SFN) scheme. When a UE transmits an SFN PUSCH, a single DCI schedules a PUSCH, where each DMRS port and/or layer of the PUSCH is transmitted from two panels with different transmit beams, different precoders, and/or different power control parameters. Each DMRS port and/or layer of the PUSCH may be associated with 2 SRS resource sets. A DCI scheduling a PUSCH can include an SRS resource set indicator field and two SRI fields. In such aspects, each of the two SRI fields indicates an SRS resource included in the SRS resource set indicated by the SRS resource set indicator field.

According to aspects of the present disclosure, dynamic switching between an sTRP scheme and an SFN scheme may be based on an SRS resource set indicator. When the SRS resource set indicator has a value of ‘00,’ then PUSCH is only associated with the first SRS resource set (which also indicates the sTRP scheme). When the SRS resource set indicator has a value of ‘01,’ then PUSCH is only associated with the second SRS resource set (which also indicated the sTRP scheme). When the SRS resource set indicator has a value of ‘10,’ then PUSCH is associated with both SRS resource sets (which also indicates the SFN scheme).

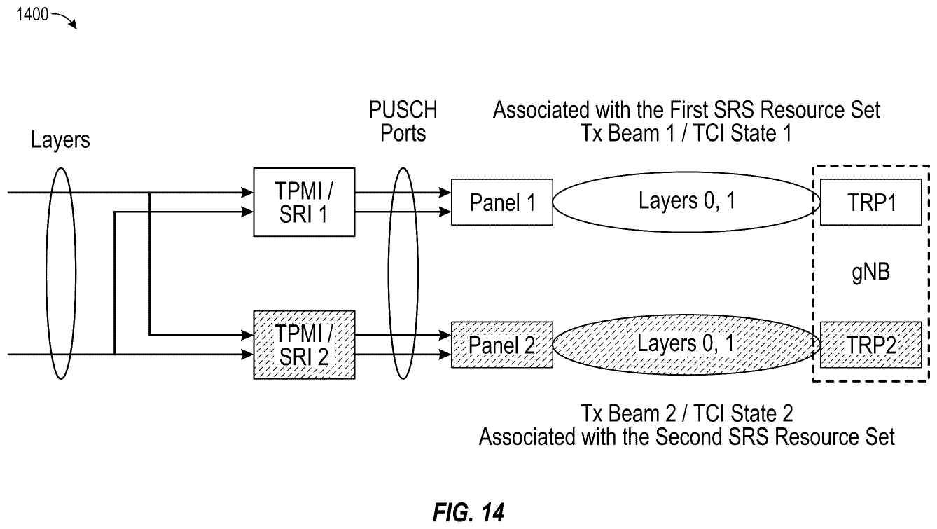

FIG. 14 shows an example 1400 of a single-DCI based SFN PUSCH STxMP scheme in block form, according to aspects of the present disclosure. As illustrated, a first layer is associated with a first TPMI or a first SRI, and the first layer is also associated with a second TPMI or a second SRI. The first layer is assigned to the PUSCH ports associated with the first TPMI or the first SRI and to the PUSCH ports associated with the second TPMI or the second SRI. Similarly, a second layer is also associated with the first TPMI or first SRI and with the second TPMI or the second SRI. The second layer is likewise assigned to the PUSCH ports associated with the first TPMI or first SRI and the second TPMI or the second SRI. The signals for transmission in the two layers are transmitted via a first panel (Panel 1) of a UE using a first beam or TCI state and form a two layer transmission on layers 0 and 1 to a first TRP (TRP 1). The signals for transmission in the two layers are also transmitted via a second panel (Panel 2) of the UE using a second beam or TCI state and form a two layer transmission on layers 2 and 3 to a second TRP (TRP 2).

### Aspects Related to Uplink Simultaneous Transmission Across Multiple Panels

In some systems (e.g., NR Rel-18 systems) a UE can simultaneously transmit two different PUSCHs in the same serving cell (e.g., in the same component carrier (CC)) by using different panels at the UE. According to aspects of the present disclosure, a wireless communication system may schedule a UE to transmit two PUSCHs using STxMP by transmitting two (or more) DCIs to cause the UE to transmit two different PUSCHs in a same serving cell and/or on a same component carrier (CC) when the two PUSCHs are partially or fully overlapping in at least the time domain. In the frequency domain, the two PUSCHs may or may not overlap.

The PUSCHs may be associated with different control resource set (CORESET) pool index values, different SRS resource sets, different beams, different transmission configuration indicator (TCI) states, different power control parameters, and/or different precoders. In some examples, one or more CORESETS are configured by RRC signaling (e.g., a ControlResourceSet IE as discussed in 3GPP TS 38.331). The CORESET includes time and frequency resources in which a UE is to search for DCI. A set of one or more CORESETs may be associated with a CORESET pool identified by a CORESET pool index value (e.g., configured in the RRC signaling via a coresetPoolIndex parameter). For example, two CORESET pools may be configured with the CORESET pool index values 0 and 1, respectively. In some examples, the CORESET pool index value associated with a transmission may be used to determine a default quasi-colocation (QCL) assumption for the transmission.

This simultaneous transmission of two different PUSCHs is different than a spatial division multiplexing (SDM) and/or frequency division multiplexing (FDM) transmission within a single PUSCH.

The first PUSCH (associated with coresetPoolIndex value 0) may be associated with the first SRS resource set and may be transmitted using a first beam, first TCI state, first set of power control parameters, and/or a first precoder.

The second PUSCH (associated with coresetPoolIndex value 1) may be associated with the second SRS resource set and may be transmitted using a second beam, second TCI state, second set of power control parameters, and/or a second precoder.

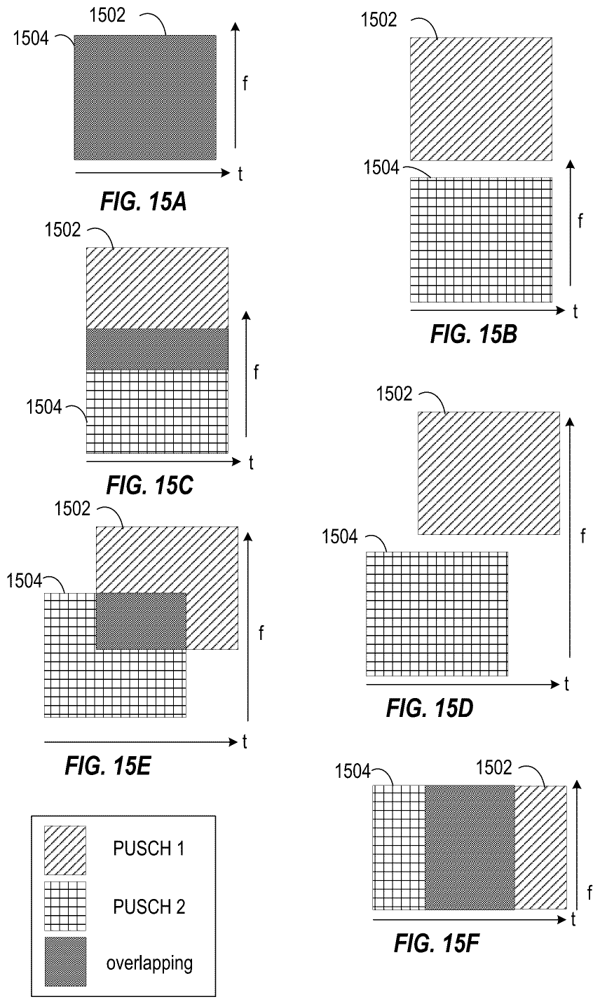

In the time domain, the PUSCHs may be scheduled and transmitted in either partially-overlapping or fully-overlapping time domain resources. In the frequency domain, the PUSCHs may be scheduled and transmitted in non-overlapping, partially-overlapping, or fully-overlapping frequency domain resources. FIG. 15A depicts simultaneous uplink transmission of a PUSCH 1502 (PUSCH 1) and a PUSCH 1504 (PUSCH 2) on resources fully-overlapping in the time domain and fully-overlapping in the frequency domain. FIG. 15B depicts example simultaneous uplink transmission of PUSCH 1502 and PUSCH 1504 on resources fully-overlapping in the time domain and non-overlapping in the frequency domain. FIG. 15C depicts simultaneous uplink transmission of PUSCH 1502 and PUSCH 1504 on resources fully-overlapping in the time domain and partially-overlapping in the frequency domain. FIG. 15D depicts example simultaneous uplink transmission of PUSCH 1502 and PUSCH 1504 on resources partially-overlapping in the time domain and non-overlapping in the frequency domain. FIG. 15E depicts example simultaneous uplink transmission of PUSCH 1502 and PUSCH 1504 on resources partially-overlapping in the time domain and partially-overlapping in the frequency domain. FIG. 15F depicts example simultaneous uplink transmission of PUSCH 1502 and PUSCH 1504 on resources partially-overlapping in the time domain and fully-overlapping in the frequency domain.

In aspects of the present disclosure, “shared digital ports” refers to a UE that can transmit P PUSCH ports, irrespective of whether the UE is using an sTRP scheme or an STxMP scheme. Hence, for the STxMP scheme, the sum of used PUSCH ports associated with the first SRS resource set and used PUSCH ports associated with the second SRS resource set should be P or smaller.

According to aspects of the present disclosure, in the case of a UE having symmetric panels, the limitation on the sum of used PUSCH ports may be met by limiting the PUSCH ports used for transmission and associated with the first SRS resource set to P/2 or smaller, and also limiting the PUSCH ports used for transmission and associated with the second SRS resource set to P/2 or smaller.

For example, in a wireless communications system (such as system 100, shown in FIG. 1), two SRS resource sets are configured for a UE. Each SRS resource set includes one SRS resource with P ports. For an sTRP or non-STxMP PUSCH transmission by the UE, one SRS resource set is indicated, and P PUSCH ports, with a one-to-one mapping to the P SRS ports of one of the two SRS resources, can be transmitted by the UE. For STxMP PUSCH transmission, both SRS resource sets are indicated, but the UE cannot transmit 2P PUSCH ports, which correspond to P SRS ports of the first SRS resource and P SRS ports of the second SRS resource.

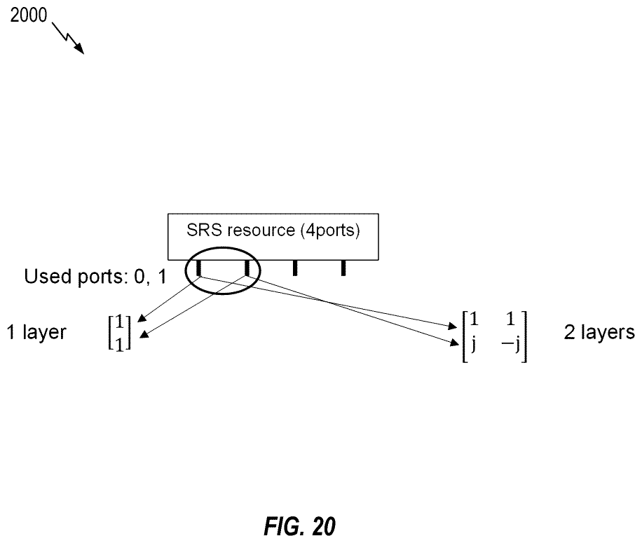

In aspects of the present disclosure, to address the issue of a UE being configured to transmit on too many ports when the UE is scheduled to make an STxMP PUSCH transmission, the PUSCH ports associated with the first SRS resource set may correspond to a subset of SRS ports of the indicated SRS resource from the first SRS resource set, and the PUSCH ports associated with the second SRS resource set may correspond to a subset of SRS ports of the indicated SRS resource from the second SRS resource set. The subsets of SRS ports above can be fixed (e.g., first P/2 SRS ports out of P SRS ports) or can be RRC configured. Having the PUSCH ports associated with the first SRS resource set corresponding to a subset of SRS ports of the indicated SRS resource from the first SRS resource set, and the PUSCH ports associated with the second SRS resource set corresponding to a subset of SRS ports of the indicated SRS resource from the second SRS resource set is shown in FIG. 20, described in more detail below.

### Aspects Related to Indicating Sounding Reference Signal Ports for Physical Uplink Shared Channels for Simultaneous Transmission Across Multiple Panels with Shared Ports

According to aspects of the present disclosure, if a UE is configured with two SRS resource sets with usage set to ‘codebook,’ and to share digital ports between panels (which may be set by assigning a value to an information element named “shared digital ports between panels”) by performing simultaneous transmission across multiple panels (STxMP), then when the UE receives a DCI scheduling an STxMP PUSCH and indicating a TPMI associated with one of the two SRS resource sets, the UE expects that one or more (at least half) of the rows of the indicated precoding matrix are zero.

In aspects of the present disclosure, the UE expecting that one or more (at least half) of the rows of the indicated precoding matrix are zero is equivalent to saying that the UE expects one or more (at least half) of the PUSCH ports and/or SRS ports are not used.

According to aspects of the present disclosure, a communication specification may include such a restriction. If a communication specification includes such a restriction, then DCIs scheduling the STxMP PUSCH may be similar to other DCIs (e.g., DCIs that schedule sTRP PUSCHs), with a similar bitwidth of a TPMI field or fields in the DCIs.

In aspects of the present disclosure, DCIs scheduling an STxMP PUSCH may have a reduced bitwidth of a TPMI field or fields in the DCI as compared with other types of DCIs.

According to aspects of the present disclosure, new tables for interpreting the “Precoding information and number of layers” field of a DCI are provided that only include the allowed TPMIs, enabling a DCI to have a reduced bitwidth of a TPMI field or fields in the DCI as compared with other types of DCIs.

In aspects of the present disclosure, a node (e.g., a UE or a network entity) may determine which table to use among the provided tables depending on at least one of a number of SRS ports of the indicated SRS resource included in one of the two SRS resource sets or a maximum rank configuration for PUSCH associated with each SRS resource set.

According to aspects of the present disclosure, the provided tables may be only for SDM and/or SFN schemes. For multiple DCIs scheduling multiple PUSCHs that partially overlap in time (described with reference to FIGS. 15A-F, above), whether the UE is expected to perform STxMP depends on whether a second DCI arrives at the UE that schedules the overlapping (i.e., second) PUSCH. Hence, the bitwidth of one DCI cannot be reduced (given that DCI size has to be fixed irrespective of other DCIs) for multiple DCIs scheduling multiple PUSCHs that partially overlap in time.

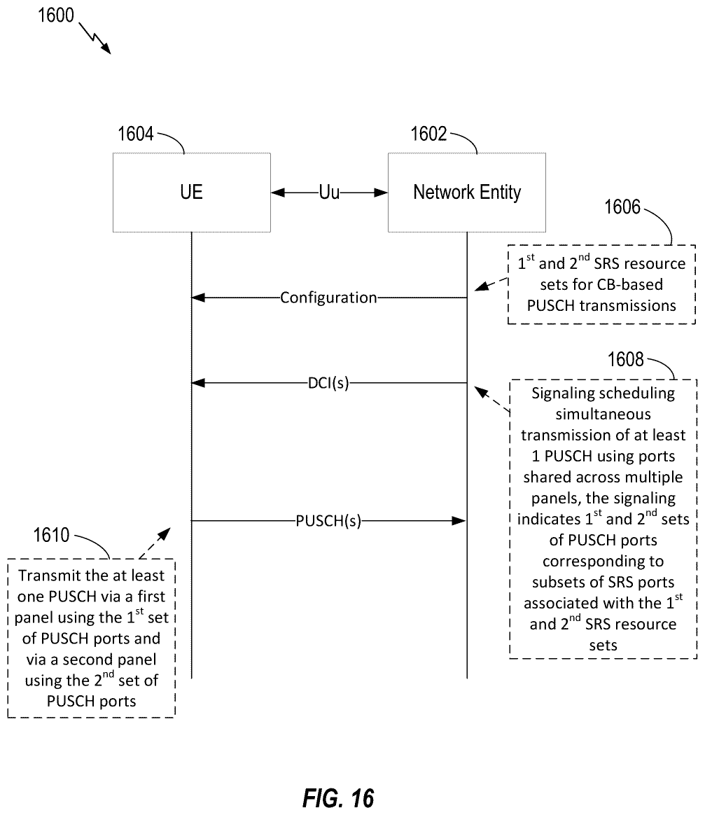

The techniques provided herein may be understood with reference to the call flow diagram 1600 of FIG. 16. The call flow diagram 1600 depicts an example set of communications between a network entity 1602 and a UE 1604. In some aspects, the network entity 1602 may be an example of the BS 102 depicted and described with respect to FIGS. 1 and 3 or a disaggregated base station depicted and described with respect to FIG. 2. Similarly, the UE 1604 may be an example of UE 104 depicted and described with respect to FIGS. 1 and 3. However, in other aspects, the UE may be another type of wireless communications device and the network entity may be another type of network entity or network node, such as those described herein.

At 1606, the UE receives, from the network entity, a configuration of at least first and second sounding reference signal (SRS) resource sets for codebook-based physical uplink shared channel (PUSCH) transmissions. The configuration may be received, for example, in RRC signaling.

At 1608, the UE receives, from the network entity, signaling scheduling the UE for simultaneous transmission of at least one PUSCH using uplink ports shared across multiple panels of the UE, wherein the signaling indicates a first set of PUSCH ports corresponding to a subset of SRS ports associated with SRS resources in the first SRS resource set and a second set of PUSCH ports corresponding to a subset of SRS ports associated with SRS resources in the second SRS resource set. The signaling may be, for example, one or more DCIs.

At 1610, the UE transmits and the network entity receives the at least one PUSCH via a first panel of the UE using the first set of PUSCH ports and via a second panel of the UE using the second set of PUSCH ports.

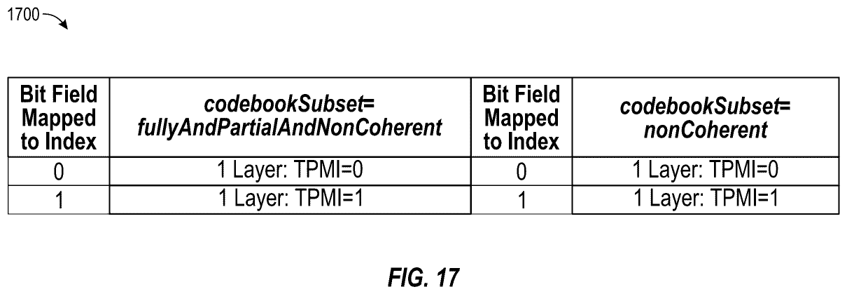

FIG. 17 shows a table 1700 for interpreting a “Precoding information and number of layers” field of a DCI scheduling STxMP PUSCHs using an SRS resource with 2 ports, with a maximum rank of 1. Such a DCI may be an example of the DCI scheduling simultaneous of at least one PUSCH using shared across multiple panels, as shown at 1608 in FIG. 16. As compared with typical DCIs, 2 bits can be saved in conveying the TPMI field if the UE is configured with codebookSubset=fullyAndPartialAndNonCoherent, as the coherent precoders are excluded. Because the coherent precoders are excluded (compare with FIG. 12) the “Precoding information and number of layers” field of a DCI may be 1 bit, instead of the 3 bits used in other types of DCIs.

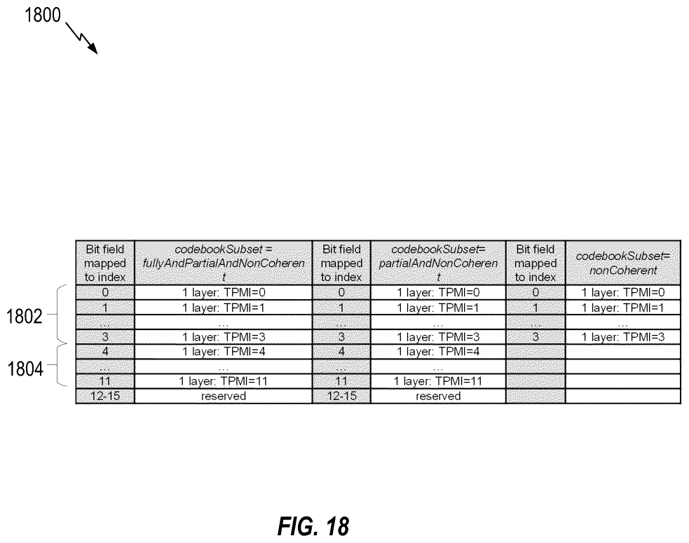

FIG. 18 shows a table 1800 for interpreting a “Precoding information and number of layers” field of a DCI scheduling STxMP PUSCHs using an SRS resource with 4 ports, with a maximum rank of 1. Such a DCI may be an example of the DCI scheduling simultaneous of at least one PUSCH using shared across multiple panels, as shown at 1608 in FIG. 16. As compared with typical DCIs, 1 bit can be saved in conveying the TPMI field if the UE is configured with codebookSubset=fullyAndPartialAndNonCoherent, as the coherent precoders are excluded. When the “Precoding information and number of layers” field in the DCI has a value between 0 and 3, inclusive, as shown at 1802, the indicated precoders are non-coherent. When the “Precoding information and number of layers” field in the DCI has a value between 4 and 11, inclusive, as shown at 1804, the indicated precoders are partial-coherent. Because the coherent precoders are excluded (compare with FIG. 11) the “Precoding information and number of layers” field of a DCI may be 4 bits, instead of the 5 bits used in other types of DCIs.

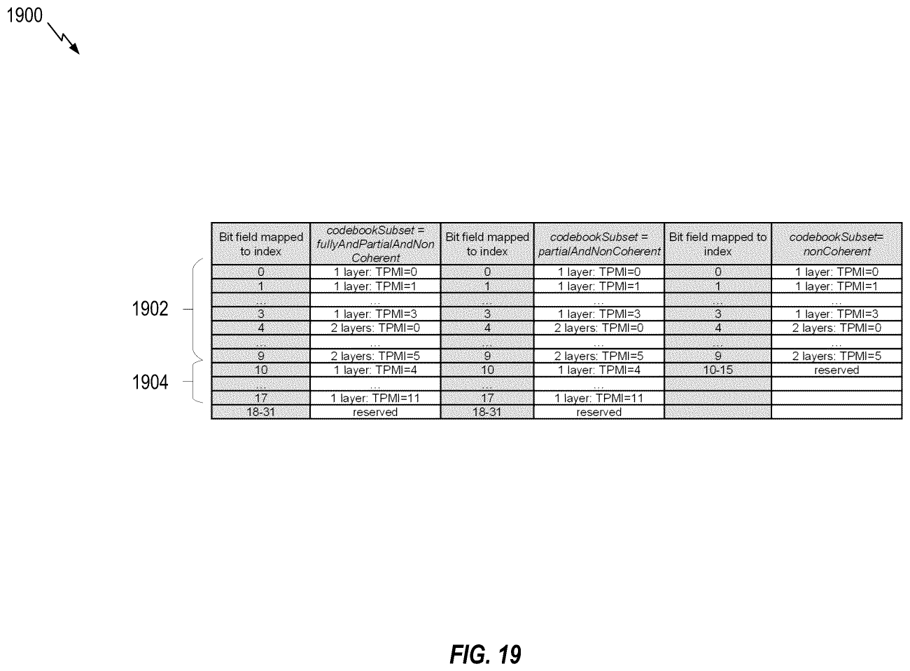

FIG. 19 shows a table 1900 for interpreting a “Precoding information and number of layers” field of a DCI scheduling STxMP PUSCHs using an SRS resource with 4 ports, with a maximum rank of 2. Such a DCI may be an example of the DCI scheduling simultaneous of at least one PUSCH using shared across multiple panels, as shown at 1608 in FIG. 16. As compared with typical DCIs, 1 bit can be saved in conveying the TPMI field if the UE is configured with codebookSubset=fullyAndPartialAndNonCoherent, as the coherent precoders for both 1 layer and 2 layers and partial-coherent precoders for 2 layers are excluded. Because the coherent precoders for both 1 layer and 2 layers and partial-coherent precoders for 2 layers are excluded (compare with FIG. 10) the “Precoding information and number of layers” field of a DCI may be 5 bits, instead of the 6 bits used in other types of DCIs. However, if the UE is configured with codebookSubset=partialAndNonCoherent, the “Precoding information and number of layers” field of a DCI is 5 bits, and no bits are saved as compared to other types of DCIs, even though the partial-coherent precoders are excluded for a maximum rank of 2.

According to aspects of the present disclosure, a node (e.g., a UE or a network entity) may consider a UE configured for transmitting using “shared digital ports between panels” (i.e., STxMP) based on one or more of: the UE indicating a capability associated with shared digital ports, the UE receiving a configuration (e.g., via RRC signaling) that enables shared digital ports (e.g., the configuration at 1606 in FIG. 16), or a configured maximum rank parameter for sTRP operation (e.g., a legacy maximum rank) is larger than a configured maximum rank parameter that is applied to each SRS resource set separately for STxMP operation.

For example, if a UE is configured with a legacy maximum rank of 4, and the new maximum rank for SDM is 2 (i.e., maximum number of layers for SDM PUSCH is 2+2=4 across layers associated with first and second SRS resource sets), then the UE may be considered configured for STxMP.

In aspects of the present disclosure, “STxMP” may be implemented as an SDM or SFN PUSCH scheme. In this case, a UE may be RRC-configured with an SDM or an SFN scheme (which may be an example of the configuration shown at 1606 in FIG. 16), and the DCI (which may be an example of the DCI shown at 1608 in FIG. 16) scheduling the PUSCH indicates both SRS resource sets (i.e., the SRS resource set indicator field is set to ‘10’). As the DCI scheduling the PUSCH indicates two TPMIs (associated with the first and second SRS resource sets, respectively), the restriction applies to each of the two TPMIs.

According to aspects of the present disclosure, “STxMP” may be implemented as multiple DCIs scheduling multiple PUSCHs. In this case, a UE may be configured with two coresetPoolIndex values associated with the two SRS resource sets, and a first DCI schedules a first PUSCH (and indicates a first TPMI), but the restriction for the TPMI is applicable only if a second DCI (associated with the other coresetPoolIndex value) schedules a second PUSCH (and indicates a second TPMI) that is partially/fully overlapping in time with the first PUSCH. In this case, the TPMI restriction applies to both the first TPMI (indicated by the first DCI for the first PUSCH) and the second TPMI (indicated by the second DCI for the second PUSCH).

Additionally or alternatively, a restriction in terms of a sum of a number of non-zero rows of the first precoding matrix indicated by the first TPMI and a number of non-zero rows of the second precoding matrix indicated by the second TPMI may be implemented. That is, the sum of the two may be restricted to being equal or smaller than a number of ports in the first SRS resource (that is in the first SRS resource set) or in the second SRS resource (that is in the second SRS resource set).

In aspects of the present disclosure, for a communications system using configured grant PUSCH (CG-PUSCH), the above described changes to DCI may be applicable except that for Type2 CG, TPMI(s) are indicated by an activation DCI and for Type1 CG, the TPMI(s) are RRC-configured.

FIG. 20 shows, in block form, an example configuration 2000 of an SRS resource wherein PUSCH ports associated with a first SRS resource set correspond to a subset of SRS ports of the indicated SRS resource from the first SRS resource set, and PUSCH ports associated with the second SRS resource set correspond to a subset of SRS ports of the indicated SRS resource from the second SRS resource set, according to aspects of the present disclosure. In the example configuration 2000, ports 0 and 1 are the subset of SRS ports that are used as the PUSCH ports when the UE is scheduled to transmit with the first SRS resource set or with the second SRS resource set. The illustrated technique enables the use of coherent precoding matrices among the subset of P/2 used PUSCH ports, as illustrated. But, the illustrated technique does not enable the dynamic selection of P/2 ports out of the P ports.

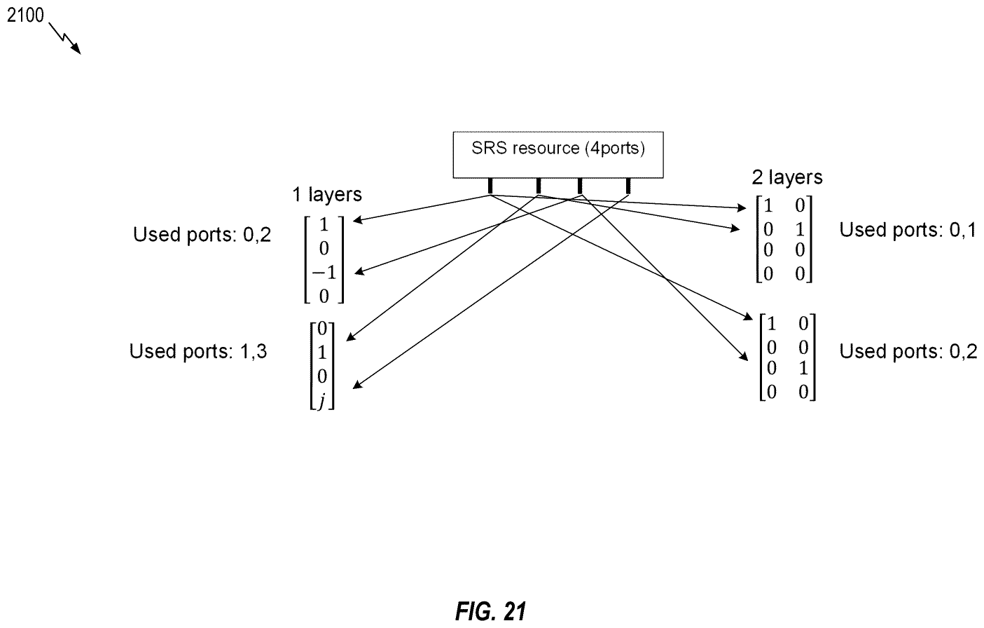

FIG. 21 shows, in block form, an example configuration 2100 of an SRS resource, wherein at least half of the rows of a precoding matrix used for a PUSCH transmission are zero, according to aspects of the present disclosure. The illustrated technique allows for dynamically selecting P/2 ports out of P ports, as indicated by the various precoder matrices having non-zero values in various rows. But, the illustrated technique does not allow for using coherent precoding matrices, or even partial-coherent precoding matrices when the UE is configured with 4 SRS ports and transmits on 2 layers. For 1-layer transmissions by a UE configured with 4 SRS ports, within 2 selected ports, the precoding matrices can be coherent. However, for dynamically selecting 2 ports out of 4, only the sets of ports {0,2} or {1,3} can be selected, but not the sets of ports {0,1}, {0,3}, etc. And, for 2-layer transmissions by a UE configured with 4 ports, within the 2 selected ports, the precoding matrices cannot be coherent.

According to aspects of the present disclosure, if a UE is configured with two SRS resource sets with usage set to ‘codebook’ and with “shared digital ports between panels” configured for “STxMP,” the UE may determine whether to follow the technique of using a fixed subset of ports, illustrated in FIG. 20, or the technique of dynamically selecting ports, illustrated in FIG. 21, based (at least in part) on one or more of: UE capability signaling; RRC configuration (e.g., the network can configure one of the two illustrated techniques); the configuration of codebookSubset (e.g., the UE follows the technique of dynamically selecting ports, as shown in FIG. 21, when codebookSubset=noncoherent or codebookSubset=partialAndNonCoherent, but the UE follows the technique of using a fixed set of ports, as shown in FIG. 20, when codebookSubset=fullyAndPartialAndNonCoherent); or a DCI dynamically indicating either a TPMI indicating a precoder matrix with a smaller size (P/2 rows) that corresponds to a fixed subset of SRS ports (thus indicating the technique of using a fixed subset of ports, as shown in FIG. 20) or indicates a TPMI indicating a precoder matrix with a number of rows equal to a number of SRS ports with some rows (P/2 rows) being zeros (thus indicating the technique of dynamically selecting ports, as shown in FIG. 21).

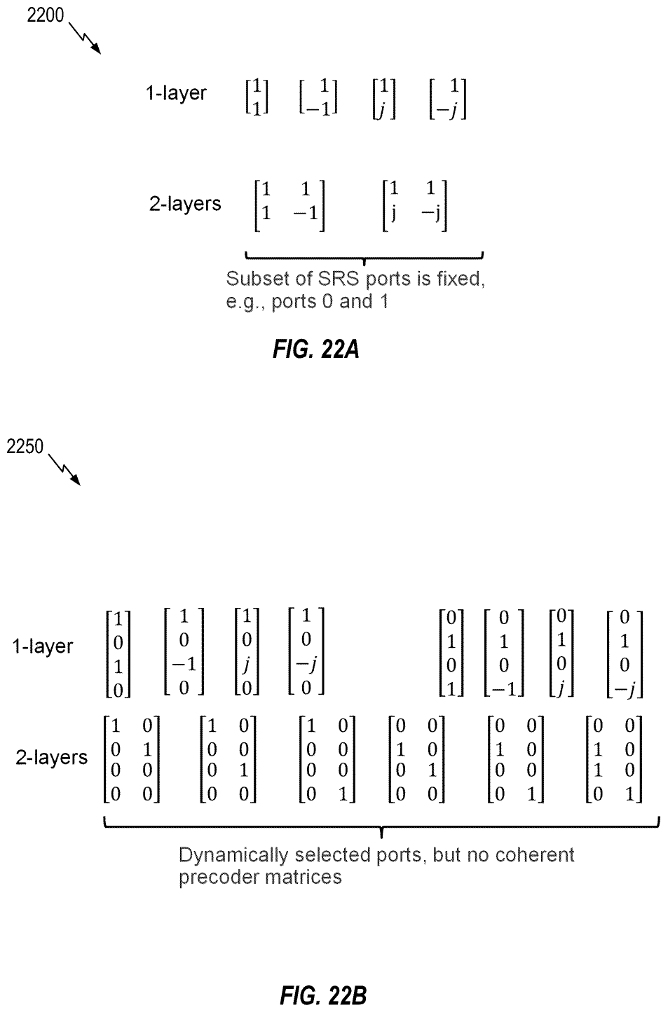

FIGS. 22A and 22B illustrate examples 2200 and 2250 of precoding matrices dynamically indicated by a “Precoding information and number of layers” field in a DCI that a UE may use in determining whether to use the technique of using a fixed subset of ports, as shown in FIG. 20, or the technique of dynamically selecting ports, as shown in FIG. 21. The DCI may be an example of the DCI shown at 1608 in FIG. 16. When a UE, configured with 4 SRS ports and a maximum rank of 2, receives a DCI with a “Precoding information and number of layers” field indicating one of the precoding matrices shown in example 2200, the UE may determine to use the technique of using a fixed subset of ports, as shown in FIG. 20, and use a fixed subset of SRS ports, e.g., ports 0 and 1. And when the UE, configured with 4 SRS ports and a maximum rank of 2, receives a DCI with a “Precoding information and number of layers” field indicating one of the precoding matrices shown in example 2250, the UE may determine to use the technique of dynamically selecting ports, as shown in FIG. 21, and transmit using the dynamically indicated subset of SRS ports, but without using any coherent precoder matrices.

According to aspects of the present disclosure, a DCI can dynamically indicate a subset of SRS ports (e.g., P/2 ports out of P SRS ports) and then indicate a TPMI across the selected ports (with P/2 rows in the precoder matrix indicated by the TPMI). This may enable the use of coherent precoder matrices with a dynamically signaled subset of ports.

In aspects of the present disclosure, the signaling of the selection of ports and of the TPMI may be performed using one field in a DCI (e.g., a “Precoding information and number of layers” field), or by separate fields in the DCI (e.g., a new field indicates the selection of ports, and “Precoding information and number of layers” field indicates the TPMI and number of layers).

### Example Operations

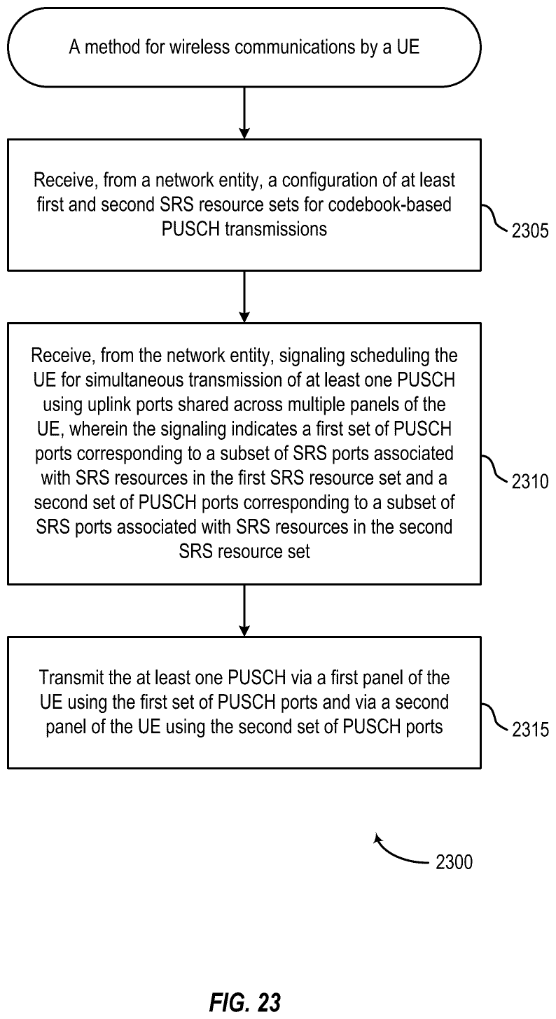

FIG. 23 shows an example of a method 2300 of wireless communications by a UE, such as a UE 104 of FIGS. 1 and 3.

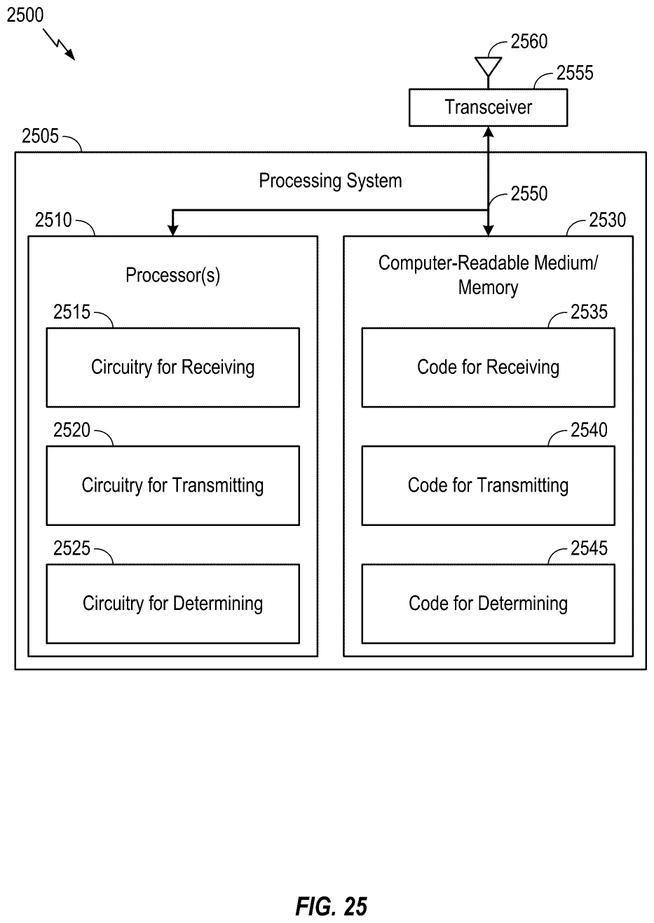

Method 2300 begins at step 2305 with receiving, from a network entity, a configuration of at least first and second SRS resource sets for codebook-based PUSCH transmissions. In some cases, the operations of this step refer to, or may be performed by, circuitry for receiving and/or code for receiving as described with reference to FIG. 25.

Method 2300 then proceeds to step 2310 with receiving, from the network entity, signaling scheduling the UE for simultaneous transmission of at least one PUSCH using uplink ports shared across multiple panels of the UE, wherein the signaling indicates a first set of PUSCH ports corresponding to a subset of SRS ports associated with SRS resources in the first SRS resource set and a second set of PUSCH ports corresponding to a subset of SRS ports associated with SRS resources in the second SRS resource set. In some cases, the operations of this step refer to, or may be performed by, circuitry for receiving and/or code for receiving as described with reference to FIG. 25.

Method 2300 then proceeds to step 2315 with transmitting the at least one PUSCH via a first panel of the UE using the first set of PUSCH ports and via a second panel of the UE using the second set of PUSCH ports. In some cases, the operations of this step refer to, or may be performed by, circuitry for transmitting and/or code for transmitting as described with reference to FIG. 25.

In some aspects, the signaling comprises DCI with a field that indicates a TPMI index associated with at least one of the first or second SRS resource set.

In some aspects, one or more rows of a precoding matrix indicated by the TPMI index have zero values indicating corresponding PUSCH ports that are not used for transmitting the at least one PUSCH.

In some aspects, the TPMI field is restricted to a limited number of valid values when the DCI schedules the UE for simultaneous transmission of the at least one PUSCH using uplink ports shared across multiple panels of the UE.

In some aspects, the UE interprets the TPMI field using a first set of tables defined for simultaneous transmission of the at least one PUSCH using uplink ports shared across multiple panels of the UE.

In some aspects, the UE selects one of the first set of tables based on: a number of SRS ports of an SRS resource indicated in the DCI and a maximum rank configuration for PUSCH associated with each of the first and second SRS resource set.

In some aspects, the method 2300 further includes determining uplink ports are shared across multiple panels of the UE based on at least one of: the UE transmitting signaling indicating a capability of the UE to support uplink ports shared across multiple panels of the UE; the UE receiving signaling enabling sharing of uplink ports across multiple panels of the UE; or a configured maximum rank parameter for single PUSCH transmission being larger than a configured maximum rank parameter for simultaneous PUSCH transmission on multiple panels. In some cases, the operations of this step refer to, or may be performed by, circuitry for determining and/or code for determining as described with reference to FIG. 25.

In some aspects, the signaling: schedules the UE for simultaneous transmission of the at least one PUSCH via SDM or SFN transmission; and indicates separate TPMI indexes associated with the first and second SRS resource sets.

In some aspects, the signaling comprises: a first DCI that schedules a first PUSCH and indicates a first TPMI; and a second DCI that schedules a second PUSCH, at least partially overlapping in time with the first PUSCH, and indicates a second TPMI.

In some aspects, there is a limit on a sum of a number of the PUSCH ports in the first set and a number of the PUSCH ports in the second set.

In some aspects, the limit is based on a number of SRS ports in an SRS resource of the first SRS resource set or an SRS resource of the second SRS resource set.

In some aspects, the method 2300 further includes determining when the signaling indicates the first set of PUSCH ports corresponding to the subset of SRS ports associated with the first SRS resource set and the second set of PUSCH ports corresponding to the subset of SRS ports associated with the second SRS resource set based on at least one of: UE capability signaling; a RRC signaling; a codebook subset configuration; or an indication in a DCI. In some cases, the operations of this step refer to, or may be performed by, circuitry for determining and/or code for determining as described with reference to FIG. 25.

In one aspect, method 2300, or any aspect related to it, may be performed by an apparatus, such as communications device 2500 of FIG. 25, which includes various components operable, configured, or adapted to perform the method 2300. Communications device 2500 is described below in further detail.

Note that FIG. 23 is just one example of a method, and other methods including fewer, additional, or alternative steps are possible consistent with this disclosure.

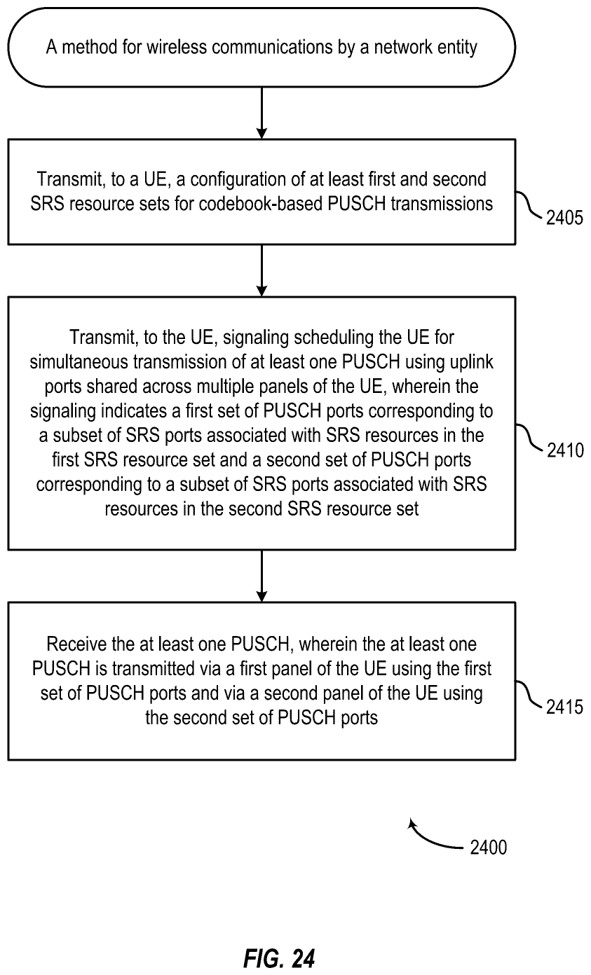

FIG. 24 shows an example of a method 2400 of wireless communications by a network entity, such as a BS 102 of FIGS. 1 and 3, or a disaggregated base station as discussed with respect to FIG. 2.

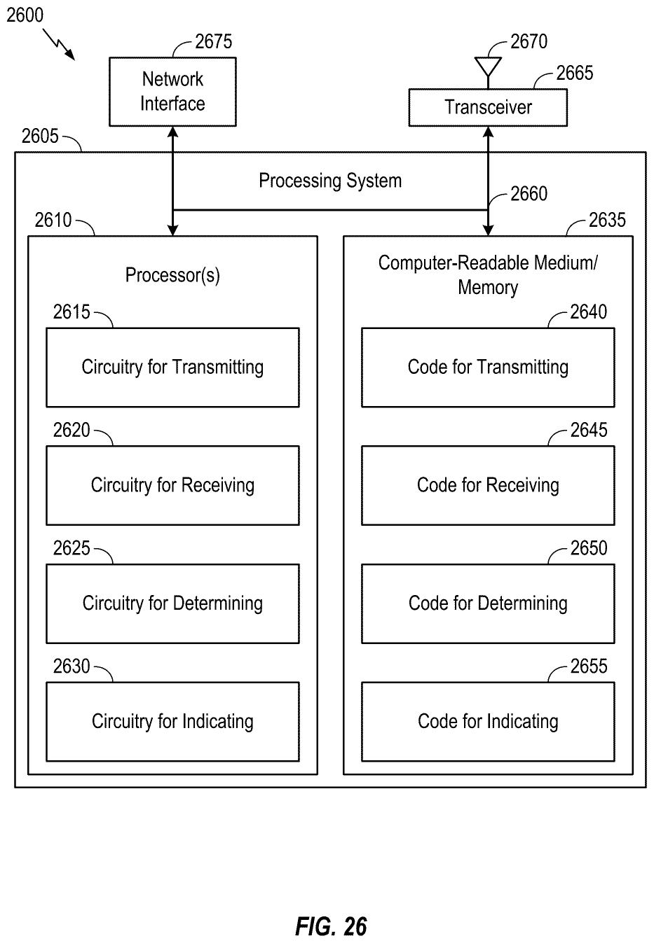

Method 2400 begins at step 2405 with transmitting, to a UE, a configuration of at least first and second SRS resource sets for codebook-based PUSCH transmissions. In some cases, the operations of this step refer to, or may be performed by, circuitry for transmitting and/or code for transmitting as described with reference to FIG. 26.

Method 2400 then proceeds to step 2410 with transmitting, to the UE, signaling scheduling the UE for simultaneous transmission of at least one PUSCH using uplink ports shared across multiple panels of the UE, wherein the signaling indicates a first set of PUSCH ports corresponding to a subset of SRS ports associated with SRS resources in the first SRS resource set and a second set of PUSCH ports corresponding to a subset of SRS ports associated with SRS resources in the second SRS resource set. In some cases, the operations of this step refer to, or may be performed by, circuitry for transmitting and/or code for transmitting as described with reference to FIG. 26.

Method 2400 then proceeds to step 2415 with receiving the at least one PUSCH, wherein the at least one PUSCH is transmitted via a first panel of the UE using the first set of PUSCH ports and via a second panel of the UE using the second set of PUSCH ports. In some cases, the operations of this step refer to, or may be performed by, circuitry for receiving and/or code for receiving as described with reference to FIG. 26.

In some aspects, the signaling comprises DCI with a field that indicates a TPMI index associated with at least one of the first or second SRS resource set.

In some aspects, one or more rows of a precoding matrix indicated by the TPMI index have zero values indicating corresponding PUSCH ports that are not used for transmitting the at least one PUSCH.

In some aspects, the TPMI field is restricted to a limited number of valid values when the DCI schedules the UE for simultaneous transmission of the at least one PUSCH using uplink ports shared across multiple panels of the UE.

In some aspects, the UE interprets the TPMI field using a first set of tables defined for simultaneous transmission of the at least one PUSCH using uplink ports shared across multiple panels of the UE.

In some aspects, the UE selects one of the first set of tables based on: a number of SRS ports of an SRS resource indicated in the DCI and a maximum rank configuration for PUSCH associated with each of the first and second SRS resource set.

In some aspects, the method 2400 further includes determining uplink ports are shared across multiple panels of the UE based on at least one of: receiving signaling, from the UE, indicating a capability of the UE to support uplink ports shared across multiple panels of the UE; transmitting signaling, to the UE, enabling sharing of uplink ports across multiple panels of the UE; or a configured maximum rank parameter for single PUSCH transmission being larger than a configured maximum rank parameter for simultaneous PUSCH transmission on multiple panels. In some cases, the operations of this step refer to, or may be performed by, circuitry for determining and/or code for determining as described with reference to FIG. 26.

In some aspects, the signaling: schedules the UE for simultaneous transmission of the at least one PUSCH via SDM or SFN transmission; and indicates separate TPMI indexes associated with the first and second SRS resource sets.

In some aspects, the signaling comprises: a first DCI that schedules a first PUSCH and indicates a first TPMI; and a second DCI that schedules a second PUSCH, at least partially overlapping in time with the first PUSCH, and indicates a second TPMI.

In some aspects, there is a limit on a sum of a number of the PUSCH ports in the first set and a number of the PUSCH ports in the second set.

In some aspects, the limit is based on a number of SRS ports in an SRS resource of the first SRS resource set or an SRS resource of the second SRS resource set.

In some aspects, the method 2400 further includes determining when the signaling indicates the first set of PUSCH ports corresponding to the subset of SRS ports associated with the first SRS resource set and the second set of PUSCH ports corresponding to the subset of SRS ports associated with the second SRS resource set based on UE capability signaling. In some cases, the operations of this step refer to, or may be performed by, circuitry for determining and/or code for determining as described with reference to FIG. 26.

In some aspects, the method 2400 further includes indicating that the first set of PUSCH ports corresponding to the subset of SRS ports is associated with the first SRS resource set and the second set of PUSCH ports corresponding to the subset of SRS ports is associated with the second SRS resource set via at least one of: a RRC signaling; a codebook subset configuration; or an indication in a DCI. In some cases, the operations of this step refer to, or may be performed by, circuitry for indicating and/or code for indicating as described with reference to FIG. 26.

In one aspect, method 2400, or any aspect related to it, may be performed by an apparatus, such as communications device 2600 of FIG. 26, which includes various components operable, configured, or adapted to perform the method 2400. Communications device 2600 is described below in further detail.

Note that FIG. 24 is just one example of a method, and other methods including fewer, additional, or alternative steps are possible consistent with this disclosure.

### Example Communications Devices

FIG. 25 depicts aspects of an example communications device 2500. In some aspects, communications device 2500 is a user equipment, such as UE 104 described above with respect to FIGS. 1 and 3.

The communications device 2500 includes a processing system 2505 coupled to the transceiver 2555 (e.g., a transmitter and/or a receiver). The transceiver 2555 is configured to transmit and receive signals for the communications device 2500 via the antenna 2560, such as the various signals as described herein. The processing system 2505 may be configured to perform processing functions for the communications device 2500, including processing signals received and/or to be transmitted by the communications device 2500.

The processing system 2505 includes one or more processors 2510. In various aspects, the one or more processors 2510 may be representative of one or more of receive processor 358, transmit processor 364, TX MIMO processor 366, and/or controller/processor 380, as described with respect to FIG. 3. The one or more processors 2510 are coupled to a computer-readable medium/memory 2530 via a bus 2550. In certain aspects, the computer-readable medium/memory 2530 is configured to store instructions (e.g., computer-executable code) that when executed by the one or more processors 2510, cause the one or more processors 2510 to perform the method 2300 described with respect to FIG. 23, or any aspect related to it. Note that reference to a processor performing a function of communications device 2500 may include one or more processors 2510 performing that function of communications device 2500.

In the depicted example, computer-readable medium/memory 2530 stores code (e.g., executable instructions), such as code for receiving 2535, code for transmitting 2540, and code for determining 2545. Processing of the code for receiving 2535, code for transmitting 2540, and code for determining 2545 may cause the communications device 2500 to perform the method 2300 described with respect to FIG. 23, or any aspect related to it.

The one or more processors 2510 include circuitry configured to implement (e.g., execute) the code stored in the computer-readable medium/memory 2530, including circuitry such as circuitry for receiving 2515, circuitry for transmitting 2520, and circuitry for determining 2525. Processing with circuitry for receiving 2515, circuitry for transmitting 2520, and circuitry for determining 2525 may cause the communications device 2500 to perform the method 2300 described with respect to FIG. 23, or any aspect related to it.

Various components of the communications device 2500 may provide means for performing the method 2300 described with respect to FIG. 23, or any aspect related to it. For example, means for transmitting, sending, or outputting for transmission may include transceivers 354 and/or antenna(s) 352 of the UE 104 illustrated in FIG. 3 and/or the transceiver 2555 and the antenna 2560 of the communications device 2500 in FIG. 25. Means for receiving or obtaining may include transceivers 354 and/or antenna(s) 352 of the UE 104 illustrated in FIG. 3 and/or the transceiver 2555 and the antenna 2560 of the communications device 2500 in FIG. 25.

FIG. 26 depicts aspects of an example communications device 2600. In some aspects, communications device 2600 is a network entity, such as BS 102 of FIGS. 1 and 3, or a disaggregated base station as discussed with respect to FIG. 2.

The communications device 2600 includes a processing system 2605 coupled to the transceiver 2665 (e.g., a transmitter and/or a receiver) and/or a network interface 2675. The transceiver 2665 is configured to transmit and receive signals for the communications device 2600 via the antenna 2670, such as the various signals as described herein. The network interface 2675 is configured to obtain and send signals for the communications device 2600 via communication link(s), such as a backhaul link, midhaul link, and/or fronthaul link as described herein, such as with respect to FIG. 2. The processing system 2605 may be configured to perform processing functions for the communications device 2600, including processing signals received and/or to be transmitted by the communications device 2600.

The processing system 2605 includes one or more processors 2610. In various aspects, one or more processors 2610 may be representative of one or more of receive processor 338, transmit processor 320, TX MIMO processor 330, and/or controller/processor 340, as described with respect to FIG. 3. The one or more processors 2610 are coupled to a computer-readable medium/memory 2635 via a bus 2660. In certain aspects, the computer-readable medium/memory 2635 is configured to store instructions (e.g., computer-executable code) that when executed by the one or more processors 2610, cause the one or more processors 2610 to perform the method 2400 described with respect to FIG. 24, or any aspect related to it. Note that reference to a processor of communications device 2600 performing a function may include one or more processors 2610 of communications device 2600 performing that function.

In the depicted example, the computer-readable medium/memory 2635 stores code (e.g., executable instructions), such as code for transmitting 2640, code for receiving 2645, code for determining 2650, and code for indicating 2655. Processing of the code for transmitting 2640, code for receiving 2645, code for determining 2650, and code for indicating 2655 may cause the communications device 2600 to perform the method 2400 described with respect to FIG. 24, or any aspect related to it.

The one or more processors 2610 include circuitry configured to implement (e.g., execute) the code stored in the computer-readable medium/memory 2635, including circuitry such as circuitry for transmitting 2615, circuitry for receiving 2620, circuitry for determining 2625, and circuitry for indicating 2630. Processing with circuitry for transmitting 2615, circuitry for receiving 2620, circuitry for determining 2625, and circuitry for indicating 2630 may cause the communications device 2600 to perform the method 2400 described with respect to FIG. 24, or any aspect related to it.

Various components of the communications device 2600 may provide means for performing the method 2400 described with respect to FIG. 24, or any aspect related to it. Means for transmitting, sending, or outputting for transmission may include transceivers 332 and/or antenna(s) 334 of the BS 102 illustrated in FIG. 3 and/or the transceiver 2665 and the antenna 2670 of the communications device 2600 in FIG. 26. Means for receiving or obtaining may include transceivers 332 and/or antenna(s) 334 of the BS 102 illustrated in FIG. 3 and/or the transceiver 2665 and the antenna 2670 of the communications device 2600 in FIG. 26.

### Example Clauses

Implementation examples are described in the following numbered clauses:

Clause 1: A method for wireless communications by a UE, comprising: receiving, from a network entity, a configuration of at least first and second SRS resource sets for codebook-based PUSCH transmissions; receiving, from the network entity, signaling scheduling the UE for simultaneous transmission of at least one PUSCH using uplink ports shared across multiple panels of the UE, wherein the signaling indicates a first set of PUSCH ports corresponding to a subset of SRS ports associated with SRS resources in the first SRS resource set and a second set of PUSCH ports corresponding to a subset of SRS ports associated with SRS resources in the second SRS resource set; and transmitting the at least one PUSCH via a first panel of the UE using the first set of PUSCH ports and via a second panel of the UE using the second set of PUSCH ports.

Clause 2: The method of Clause 1, wherein the signaling comprises DCI with a field that indicates a TPMI index associated with at least one of the first or second SRS resource set.

Clause 3: The method of Clause 2, wherein one or more rows of a precoding matrix indicated by the TPMI index have zero values indicating corresponding PUSCH ports that are not used for transmitting the at least one PUSCH.

Clause 4: The method of Clause 3, wherein the TPMI field is restricted to a limited number of valid values when the DCI schedules the UE for simultaneous transmission of the at least one PUSCH using uplink ports shared across multiple panels of the UE.

Clause 5: The method of Clause 3, wherein: the UE interprets the TPMI field using a first set of tables defined for simultaneous transmission of the at least one PUSCH using uplink ports shared across multiple panels of the UE.

Clause 6: The method of Clause 5, wherein the UE selects one of the first set of tables based on: a number of SRS ports of an SRS resource indicated in the DCI and a maximum rank configuration for PUSCH associated with each of the first and second SRS resource set.

Clause 7: The method of any one of Clauses 1-6, further comprising determining uplink ports are shared across multiple panels of the UE based on at least one of: the UE transmitting signaling indicating a capability of the UE to support uplink ports shared across multiple panels of the UE; the UE receiving signaling enabling sharing of uplink ports across multiple panels of the UE; or a configured maximum rank parameter for single PUSCH transmission being larger than a configured maximum rank parameter for simultaneous PUSCH transmission on multiple panels.

Clause 8: The method of any one of Clauses 1-7, wherein the signaling: schedules the UE for simultaneous transmission of the at least one PUSCH via SDM or SFN transmission; and indicates separate TPMI indexes associated with the first and second SRS resource sets.

Clause 9: The method of any one of Clauses 1-8, wherein the signaling comprises: a first DCI that schedules a first PUSCH and indicates a first TPMI; and a second DCI that schedules a second PUSCH, at least partially overlapping in time with the first PUSCH, and indicates a second TPMI.

Clause 10: The method of any one of Clauses 1-9, wherein there is a limit on a sum of a number of the PUSCH ports in the first set and a number of the PUSCH ports in the second set.

Clause 11: The method of Clause 10, wherein the limit is based on a number of SRS ports in an SRS resource of the first SRS resource set or an SRS resource of the second SRS resource set.

Clause 12: The method of any one of Clauses 1-11, further comprising determining when the signaling indicates the first set of PUSCH ports corresponding to the subset of SRS ports associated with the first SRS resource set and the second set of PUSCH ports corresponding to the subset of SRS ports associated with the second SRS resource set based on at least one of: UE capability signaling; a RRC signaling; a codebook subset configuration; or an indication in a DCI.

Clause 13: A method for wireless communications by a network entity, comprising: transmitting, to a UE, a configuration of at least first and second SRS resource sets for codebook-based PUSCH transmissions; transmitting, to the UE, signaling scheduling the UE for simultaneous transmission of at least one PUSCH using uplink ports shared across multiple panels of the UE, wherein the signaling indicates a first set of PUSCH ports corresponding to a subset of SRS ports associated with SRS resources in the first SRS resource set and a second set of PUSCH ports corresponding to a subset of SRS ports associated with SRS resources in the second SRS resource set; and receiving the at least one PUSCH, wherein the at least one PUSCH is transmitted via a first panel of the UE using the first set of PUSCH ports and via a second panel of the UE using the second set of PUSCH ports.

Clause 14: The method of Clause 13, wherein the signaling comprises DCI with a field that indicates a TPMI index associated with at least one of the first or second SRS resource set.

Clause 15: The method of Clause 14, wherein one or more rows of a precoding matrix indicated by the TPMI index have zero values indicating corresponding PUSCH ports that are not used for transmitting the at least one PUSCH.

Clause 16: The method of Clause 15, wherein the TPMI field is restricted to a limited number of valid values when the DCI schedules the UE for simultaneous transmission of the at least one PUSCH using uplink ports shared across multiple panels of the UE.

Clause 17: The method of Clause 15, wherein: the UE interprets the TPMI field using a first set of tables defined for simultaneous transmission of the at least one PUSCH using uplink ports shared across multiple panels of the UE.

Clause 18: The method of Clause 17, wherein the UE selects one of the first set of tables based on: a number of SRS ports of an SRS resource indicated in the DCI and a maximum rank configuration for PUSCH associated with each of the first and second SRS resource set.

Clause 19: The method of any one of Clauses 13-18, further comprising determining uplink ports are shared across multiple panels of the UE based on at least one of: receiving signaling, from the UE, indicating a capability of the UE to support uplink ports shared across multiple panels of the UE; transmitting signaling, to the UE, enabling sharing of uplink ports across multiple panels of the UE; or a configured maximum rank parameter for single PUSCH transmission being larger than a configured maximum rank parameter for simultaneous PUSCH transmission on multiple panels.

Clause 20: The method of any one of Clauses 13-19, wherein the signaling: schedules the UE for simultaneous transmission of the at least one PUSCH via SDM or SFN transmission; and indicates separate TPMI indexes associated with the first and second SRS resource sets.

Clause 21: The method of any one of Clauses 13-20, wherein the signaling comprises: a first DCI that schedules a first PUSCH and indicates a first TPMI; and a second DCI that schedules a second PUSCH, at least partially overlapping in time with the first PUSCH, and indicates a second TPMI.

Clause 22: The method of any one of Clauses 13-21, wherein there is a limit on a sum of a number of the PUSCH ports in the first set and a number of the PUSCH ports in the second set.

Clause 23: The method of Clause 22, wherein the limit is based on a number of SRS ports in an SRS resource of the first SRS resource set or an SRS resource of the second SRS resource set.

Clause 24: The method of any one of Clauses 13-23, further comprising determining when the signaling indicates the first set of PUSCH ports corresponding to the subset of SRS ports associated with the first SRS resource set and the second set of PUSCH ports corresponding to the subset of SRS ports associated with the second SRS resource set based on UE capability signaling.

Clause 25: The method of any one of Clauses 13-24, further comprising indicating that the first set of PUSCH ports corresponding to the subset of SRS ports is associated with the first SRS resource set and the second set of PUSCH ports corresponding to the subset of SRS ports is associated with the second SRS resource set via at least one of: a RRC signaling; a codebook subset configuration; or an indication in a DCI.

Clause 26: An apparatus, comprising: at least one memory comprising executable instructions; and one or more processors configured to execute the executable instructions and cause the apparatus to perform a method in accordance with any one of Clauses 1-25.

Clause 27: An apparatus, comprising means for performing a method in accordance with any one of Clauses 1-25.

Clause 28: A non-transitory computer-readable medium comprising executable instructions that, when executed by a processor of an apparatus, cause the apparatus to perform a method in accordance with any one of Clauses 1-25.

Clause 29: A computer program product embodied on a computer-readable storage medium comprising code for performing a method in accordance with any one of Clauses 1-25.

Clause 30: A user equipment (UE) configured for wireless communications, comprising: a memory comprising computer-executable instructions; and a processor configured to execute the computer-executable instructions and cause the UE to: receive, from a network entity, a configuration of at least first and second sounding reference signal (SRS) resource sets for codebook-based physical uplink shared channel (PUSCH) transmissions; receive, from the network entity, signaling scheduling the UE for simultaneous transmission of at least one PUSCH using uplink ports shared across multiple panels of the UE, wherein the signaling indicates a first set of PUSCH ports corresponding to a subset of SRS ports associated with SRS resources in the first SRS resource set and a second set of PUSCH ports corresponding to a subset of SRS ports associated with SRS resources in the second SRS resource set; and transmit the at least one PUSCH via a first panel of the UE using the first set of PUSCH ports and via a second panel of the UE using the second set of PUSCH ports.

Clause 31: The UE of Clause 30, wherein the processor being configured to execute the computer-executable instructions to cause the UE to receive the signaling comprises the processor being configured to execute the computer-executable instructions and cause the UE to receive downlink control information (DCI) with a field that indicates a transmitted precoding matrix indicator (TPMI) index associated with at least one of the first or second SRS resource set.

Clause 32: The UE of Clause 31, wherein one or more rows of a precoding matrix indicated by the TPMI index have zero values indicating corresponding PUSCH ports that are not used for transmitting the at least one PUSCH.

Clause 33: The UE of Clause 32, wherein the TPMI field is restricted to a limited number of valid values when the DCI schedules the UE for simultaneous transmission of the at least one PUSCH using uplink ports shared across multiple panels of the UE.

Clause 34: The UE of Clause 32, wherein the processor is configured to execute the computer-executable instructions and further cause the UE to: interpret the TPMI field using a first set of tables defined for simultaneous transmission of the at least one PUSCH using uplink ports shared across multiple panels of the UE.

Clause 35: The UE of Clause 34, wherein the processor is configured to execute the computer-executable instructions and further cause the UE to select one of the first set of tables based on a number of SRS ports of an SRS resource indicated in the DCI and a maximum rank configuration for PUSCH associated with each of the first and second SRS resource set.

Clause 36: The UE of Clause 30, wherein the processor is configured to execute the computer-executable instructions and further cause the UE to determine uplink ports are shared across multiple panels of the UE based on at least one of: the UE transmitting signaling indicating a capability of the UE to support uplink ports shared across multiple panels of the UE; the UE receiving signaling enabling sharing of uplink ports across multiple panels of the UE; or a configured maximum rank parameter for single PUSCH transmission being larger than a configured maximum rank parameter for simultaneous PUSCH transmission on multiple panels.

Clause 37: The UE of Clause 30, wherein the processor is configured to execute the computer-executable instructions and, based on the signaling, further cause the UE to: simultaneously transmit the at least one PUSCH via spatial division multiplexing (SDM) or single frequency network (SFN) transmission; and determine separate transmitted precoding matrix indicator (TPMI) indexes associated with the first and second SRS resource sets.

Clause 38: The UE of Clause 30, wherein the processor being configured to execute the computer-executable instructions and cause the UE to receive the signaling comprises the processor being configured to execute the computer-executable instructions and cause the UE to receive: a first downlink control information (DCI) that schedules a first PUSCH and indicates a first TPMI; and a second DCI that schedules a second PUSCH, at least partially overlapping in time with the first PUSCH, and indicates a second TPMI.

Clause 39: The UE of Clause 30, wherein there is a limit on a sum of a number of the PUSCH ports in the first set and a number of the PUSCH ports in the second set.

Clause 40: The UE of Clause 39, wherein the limit is based on a number of SRS ports in an SRS resource of the first SRS resource set or an SRS resource of the second SRS resource set.

Clause 41: The UE of Clause 30, wherein the processor is configured to execute the computer-executable instructions and further cause the UE to determine when the signaling indicates the first set of PUSCH ports corresponding to the subset of SRS ports associated with the first SRS resource set and the second set of PUSCH ports corresponding to the subset of SRS ports associated with the second SRS resource set based on at least one of: capability signaling by the UE; a radio resource control (RRC) signaling; a codebook subset configuration; or an indication in a downlink control information (DCI).

Clause 42: A network entity configured for wireless communications, comprising: a memory comprising computer-executable instructions; and a processor configured to execute the computer-executable instructions and cause the network entity to: transmit, to a user equipment (UE), a configuration of at least first and second sounding reference signal (SRS) resource sets for codebook-based physical uplink shared channel (PUSCH) transmissions; transmit, to the UE, signaling scheduling the UE for simultaneous transmission of at least one PUSCH using uplink ports shared across multiple panels of the UE, wherein the signaling indicates a first set of PUSCH ports corresponding to a subset of SRS ports associated with SRS resources in the first SRS resource set and a second set of PUSCH ports corresponding to a subset of SRS ports associated with SRS resources in the second SRS resource set; and receive the at least one PUSCH, wherein the at least one PUSCH is transmitted via a first panel of the UE using the first set of PUSCH ports and via a second panel of the UE using the second set of PUSCH ports.

Clause 43: The network entity of Clause 42, wherein the processor being configured to execute the computer-executable instructions and cause the network entity to transmit the signaling comprises the processor being configured to execute the computer-executable instructions and cause the network entity to transmit downlink control information (DCI) with a field that indicates a transmitted precoding matrix indicator (TPMI) index associated with at least one of the first or second SRS resource set.

Clause 44: The network entity of Clause 43, wherein the processor is configured to execute the computer-executable instructions and further cause the network entity to select the TPMI index such that one or more rows of a precoding matrix indicated by the TPMI index have zero values indicating corresponding PUSCH ports that are not used for transmitting the at least one PUSCH.

Clause 45: The network entity of Clause 44, wherein the processor is configured to execute the computer-executable instructions and further cause the network entity to restrict the TPMI field to a limited number of valid values when the DCI schedules the UE for simultaneous transmission of the at least one PUSCH using uplink ports shared across multiple panels of the UE.

Clause 46: The network entity of Clause 44, wherein the processor is configured to execute the computer-executable instructions and further cause the network entity to: select the TPMI field based on a first set of tables defined for simultaneous transmission of the at least one PUSCH using uplink ports shared across multiple panels of the UE.

Clause 47: The network entity of Clause 46, wherein the processor is configured to execute the computer-executable instructions and further cause the network entity to select one of the first set of tables based on: a number of SRS ports of an SRS resource indicated in the DCI and a maximum rank configuration for PUSCH associated with each of the first and second SRS resource set.

Clause 48: The network entity of Clause 42, wherein the processor is configured to execute the computer-executable instructions and further cause the network entity to determine uplink ports are shared across multiple panels of the UE based on at least one of: receiving signaling, from the UE, indicating a capability of the UE to support uplink ports shared across multiple panels of the UE; transmitting signaling, to the UE, enabling sharing of uplink ports across multiple panels of the UE; or a configured maximum rank parameter for single PUSCH transmission being larger than a configured maximum rank parameter for simultaneous PUSCH transmission on multiple panels.

Clause 49: The network entity of Clause 42, wherein the processor being configured to execute the computer-executable instructions and cause the network entity to transmit the signaling comprises the processor being configured to execute the computer-executable instructions and cause the network entity to: schedule the UE for simultaneous transmission of the at least one PUSCH via spatial division multiplexing (SDM) or single frequency network (SFN) transmission; and indicate separate transmitted precoding matrix indicator (TPMI) indexes associated with the first and second SRS resource sets.

Clause 50: The network entity of Clause 42, wherein the processor being configured to execute the computer-executable instructions and cause the network entity to transmit the signaling comprises the processor being configured to execute the computer-executable instructions and cause the network entity to transmit: a first downlink control information (DCI) that schedules a first PUSCH and indicates a first TPMI; and a second DCI that schedules a second PUSCH, at least partially overlapping in time with the first PUSCH, and indicates a second TPMI.

Clause 51: The network entity of Clause 42, wherein the processor is configured to execute the computer-executable instructions and cause the network entity to transmit the signaling based on a limit on a sum of a number of the PUSCH ports in the first set and a number of the PUSCH ports in the second set.

Clause 52: The network entity of Clause 51, wherein the limit is based on a number of SRS ports in an SRS resource of the first SRS resource set or an SRS resource of the second SRS resource set.

Clause 53: The network entity of Clause 42, wherein the processor is configured to execute the computer-executable instructions and further cause the network entity to determine when the signaling indicates the first set of PUSCH ports corresponding to the subset of SRS ports associated with the first SRS resource set and the second set of PUSCH ports corresponding to the subset of SRS ports associated with the second SRS resource set based on UE capability signaling.

Clause 54: The method of Clause 42, wherein the processor is configured to execute the computer-executable instructions and further cause the network entity to indicate that the first set of PUSCH ports corresponding to the subset of SRS ports is associated with the first SRS resource set and the second set of PUSCH ports corresponding to the subset of SRS ports is associated with the second SRS resource set via at least one of: a radio resource control (RRC) signaling; a codebook subset configuration; or an indication in a downlink control information (DCI).

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication at a user equipment (UE), comprising:
at least one memory comprising computer-executable instructions; and
one or more processors configured to execute the computer-executable instructions and cause the UE to:
receive, from a network entity, a configuration of at least first and second sounding reference signal (SRS) resource sets for codebook-based physical uplink shared channel (PUSCH) transmissions;
receive, from the network entity, signaling scheduling the UE for simultaneous transmission of at least one PUSCH using uplink ports shared across multiple panels of the UE, wherein the signaling indicates a first set of PUSCH ports corresponding to a subset of SRS ports associated with SRS resources in the first SRS resource set and a second set of PUSCH ports corresponding to a subset of SRS ports associated with SRS resources in the second SRS resource set; and
transmit the at least one PUSCH via a first panel of the UE using the first set of PUSCH ports and via a second panel of the UE using the second set of PUSCH ports.

2. The apparatus of claim 1, wherein receiving the signaling comprises receiving downlink control information (DCI) with a field that indicates a transmitted precoding matrix indicator (TPMI) index associated with at least one of the first SRS resource set or the second SRS resource set.

3. The apparatus of claim 2, wherein one or more rows of a precoding matrix indicated by the TPMI index have zero values indicating corresponding PUSCH ports that are not used for transmitting the at least one PUSCH.

4. The apparatus of claim 3, wherein the TPMI field is restricted to a limited number of valid values when the DCI schedules the UE for simultaneous transmission of the at least one PUSCH using uplink ports shared across multiple panels of the UE.

5. The apparatus of claim 3, wherein the one or more processors are further configured to cause the UE to:
interpret the TPMI field using a first set of tables defined for simultaneous transmission of the at least one PUSCH using uplink ports shared across multiple panels of the UE.

6. The apparatus of claim 5, wherein the one or more processors are further configured to cause the UE to select one of the first set of tables based on a number of SRS ports of an SRS resource indicated in the DCI and a maximum rank configuration for PUSCH associated with each of the first and second SRS resource set.

7. The apparatus of claim 1, wherein the one or more processors are further configured to cause the UE to determine uplink ports are shared across multiple panels of the UE based on at least one of:
the UE transmitting signaling indicating a capability of the UE to support uplink ports shared across multiple panels of the UE;
the UE receiving signaling enabling sharing of uplink ports across multiple panels of the UE; or
a configured maximum rank parameter for single PUSCH transmission being larger than a configured maximum rank parameter for simultaneous PUSCH transmission on multiple panels.

8. The apparatus of claim 1, wherein the one or more processors are further configured to cause, based on the signaling, the UE to:
simultaneously transmit the at least one PUSCH via spatial division multiplexing (SDM) or single frequency network (SFN) transmission; and
determine separate transmitted precoding matrix indicator (TPMI) indexes associated with the first SRS resource set and the second SRS resource set.

9. The apparatus of claim 1, wherein receiving the signaling comprises receiving:
a first downlink control information (DCI) that schedules a first PUSCH and indicates a first TPMI; and
a second DCI that schedules a second PUSCH, at least partially overlapping in time with the first PUSCH, and indicates a second TPMI.

10. The apparatus of claim 1, wherein there is a limit on a sum of a number of the PUSCH ports in the first set and a number of the PUSCH ports in the second set.

11. The apparatus of claim 10, wherein the limit is based on a number of SRS ports in an SRS resource of the first SRS resource set or an SRS resource of the second SRS resource set.

12. The apparatus of claim 1, wherein the one or more processors are further configured to cause the UE to determine when the signaling indicates the first set of PUSCH ports corresponding to the subset of SRS ports associated with the first SRS resource set and the second set of PUSCH ports corresponding to the subset of SRS ports associated with the second SRS resource set based on at least one of:
capability signaling by the UE;
a radio resource control (RRC) signaling;
a codebook subset configuration; or
an indication in a downlink control information (DCI).

13. An apparatus for wireless communications at a network entity, comprising:
at least one memory comprising computer-executable instructions; and
one or more processors configured to execute the computer-executable instructions and cause the network entity to:
transmit, to a user equipment (UE), a configuration of at least first and second sounding reference signal (SRS) resource sets for codebook-based physical uplink shared channel (PUSCH) transmissions;
transmit, to the UE, signaling scheduling the UE for simultaneous transmission of at least one PUSCH using uplink ports shared across multiple panels of the UE, wherein the signaling indicates a first set of PUSCH ports corresponding to a subset of SRS ports associated with SRS resources in the first SRS resource set and a second set of PUSCH ports corresponding to a subset of SRS ports associated with SRS resources in the second SRS resource set; and
receive the at least one PUSCH, wherein the at least one PUSCH is transmitted via a first panel of the UE using the first set of PUSCH ports and via a second panel of the UE using the second set of PUSCH ports.

14. The apparatus of claim 13, wherein transmitting the signaling comprises transmitting downlink control information (DCI) with a field that indicates a transmitted precoding matrix indicator (TPMI) index associated with at least one of the first SRS resource set or the second SRS resource set.

15. The apparatus of claim 14, wherein the one or more processors are further configured to cause the network entity to select the TPMI index such that one or more rows of a precoding matrix indicated by the TPMI index have zero values indicating corresponding PUSCH ports that are not used for transmitting the at least one PUSCH.

16. The apparatus of claim 15, wherein the one or more processors are further configured to cause the network entity to restrict the TPMI field to a limited number of valid values when the DCI schedules the UE for simultaneous transmission of the at least one PUSCH using uplink ports shared across multiple panels of the UE.

17. The apparatus of claim 15, wherein the one or more processors are further configured to cause the network entity to:
select the TPMI field based on a first set of tables defined for simultaneous transmission of the at least one PUSCH using uplink ports shared across multiple panels of the UE.

18. The apparatus of claim 17, wherein the one or more processors are further configured to cause the network entity to select one of the first set of tables based on: a number of SRS ports of an SRS resource indicated in the DCI and a maximum rank configuration for PUSCH associated with each of the first SRS resource set and the second SRS resource set.

19. The apparatus of claim 13, wherein the one or more processors are further configured to cause the network entity to determine uplink ports are shared across multiple panels of the UE based on at least one of:
receiving signaling, from the UE, indicating a capability of the UE to support uplink ports shared across multiple panels of the UE;
transmitting signaling, to the UE, enabling sharing of uplink ports across multiple panels of the UE; or
a configured maximum rank parameter for single PUSCH transmission being larger than a configured maximum rank parameter for simultaneous PUSCH transmission on multiple panels.

20. The apparatus of claim 13, wherein transmitting the signaling comprises causing the network entity to:
schedule the UE for simultaneous transmission of the at least one PUSCH via spatial division multiplexing (SDM) or single frequency network (SFN) transmission; and
indicate separate transmitted precoding matrix indicator (TPMI) indexes associated with the first SRS resource set and the second SRS resource set.

21. The apparatus of claim 13, wherein transmitting the signaling comprises transmitting:
a first downlink control information (DCI) that schedules a first PUSCH and indicates a first TPMI; and
a second DCI that schedules a second PUSCH, at least partially overlapping in time with the first PUSCH, and indicates a second TPMI.

22. The apparatus of claim 13, wherein the one or more processors are further configured to cause the network entity to transmit the signaling based on a limit on a sum of a number of the PUSCH ports in the first set and a number of the PUSCH ports in the second set.

23. The apparatus of claim 22, wherein the limit is based on a number of SRS ports in an SRS resource of the first SRS resource set or an SRS resource of the second SRS resource set.

24. The apparatus of claim 13, wherein the one or more processors are further configured to cause the network entity to determine when the signaling indicates the first set of PUSCH ports corresponding to the subset of SRS ports associated with the first SRS resource set and the second set of PUSCH ports corresponding to the subset of SRS ports associated with the second SRS resource set based on UE capability signaling.

25. The apparatus of claim 13, wherein the one or more processors are further configured to cause the network entity to indicate that the first set of PUSCH ports corresponding to the subset of SRS ports is associated with the first SRS resource set and the second set of PUSCH ports corresponding to the subset of SRS ports is associated with the second SRS resource set via at least one of:
a radio resource control (RRC) signaling;
a codebook subset configuration; or
an indication in a downlink control information (DCI).

26. A method for wireless communications by a user equipment (UE), comprising:
receiving, from a network entity, a configuration of at least first and second sounding reference signal (SRS) resource sets for codebook-based physical uplink shared channel (PUSCH) transmissions;
receiving, from the network entity, signaling scheduling the UE for simultaneous transmission of at least one PUSCH using uplink ports shared across multiple panels of the UE, wherein the signaling indicates a first set of PUSCH ports corresponding to a subset of SRS ports associated with SRS resources in the first SRS resource set and a second set of PUSCH ports corresponding to a subset of SRS ports associated with SRS resources in the second SRS resource set; and
transmitting the at least one PUSCH via a first panel of the UE using the first set of PUSCH ports and via a second panel of the UE using the second set of PUSCH ports.

27. The method of claim 26, wherein the signaling comprises downlink control information (DCI) with a field that indicates a transmitted precoding matrix indicator (TPMI) index associated with at least one of the first SRS resource set or the second SRS resource set.

28. The method of claim 26, further comprising determining uplink ports are shared across multiple panels of the UE based on at least one of:
the UE transmitting signaling indicating a capability of the UE to support uplink ports shared across multiple panels of the UE;
the UE receiving signaling enabling sharing of uplink ports across multiple panels of the UE; or
a configured maximum rank parameter for single PUSCH transmission being larger than a configured maximum rank parameter for simultaneous PUSCH transmission on multiple panels.

29. The method of claim 26, wherein:
the signaling schedules the UE for simultaneous transmission of the at least one PUSCH via spatial division multiplexing (SDM) or single frequency network (SFN) transmission; and
the signaling indicates separate transmitted precoding matrix indicator (TPMI) indexes associated with the first SRS resource set and the second SRS resource set.

30. A method for wireless communications by a network entity, comprising:
transmitting, to a user equipment (UE), a configuration of at least first and second sounding reference signal (SRS) resource sets for codebook-based physical uplink shared channel (PUSCH) transmissions;
transmitting, to the UE, signaling scheduling the UE for simultaneous transmission of at least one PUSCH using uplink ports shared across multiple panels of the UE, wherein the signaling indicates a first set of PUSCH ports corresponding to a subset of SRS ports associated with SRS resources in the first SRS resource set and a second set of PUSCH ports corresponding to a subset of SRS ports associated with SRS resources in the second SRS resource set; and
receiving the at least one PUSCH, wherein the at least one PUSCH is transmitted via a first panel of the UE using the first set of PUSCH ports and via a second panel of the UE using the second set of PUSCH ports.
